(19) United States
(12) Patent Application Publication
(10) Pub. No.: US 2009/0086174 A1
(43) Pub. Date: Apr. 2, 2009

(54) IMAGE RECORDING APPARATUS, IMAGE CORRECTING APPARATUS, AND IMAGE SENSING APPARATUS

(75) Inventors: Shimpei FUKUMOTO, Higashiosaka City (JP); Haruo HATANAKA, Kyoto City (JP); Haruhiko MURATA, Ibaraki City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/237,973

(22) Filed: Sep. 25, 2008

(30) Foreign Application Priority Data
Sep. 28, 2007 (JP) JP2007-255217
Sep. 28, 2007 (JP) JP2007-255228

(51) Int. Cl. G03B 29/00; G03B 27/68

(52) U.S. Cl. 355/29; 355/52

(57) ABSTRACT

An image recording apparatus for acquiring a main image from an image sensing portion and recording the main image on a recording medium has: an image acquirer that acquires, when acquiring the main image from the image sensing portion, also a short-exposure image shot with an exposure time shorter than an exposure time of the main image; a partial image cutter that cuts out a partial image from the short-exposure image; and a recording controller that records, on the recording medium, in association with the main image, a sub image obtained from the partial image, along with the cut-out position of the partial image.

This nonprovisional application claims priority under 35 U.S.C. § 119(a) on Patent Application No. 2007-255228 filed in Japan on Sep. 28, 2007 and Patent Application No. 2007-255217 filed in Japan on Sep. 28, 2007, the entire contents of which are hereby incorporated by reference.

### BACKGROUND OF THE INVENTION

1. Field of the Invention

The present invention relates to an image recording apparatus for recording an image obtained by shooting, and to an image correcting apparatus for correcting such an image. The present invention also relates to an image sensing apparatus such as digital still cameras.

2. Description of Related Art

Camera shake correction is a technology for reducing blur in an image due to blur, and is deemed crucial as a differentiating technology in image sensing apparatuses such as digital still cameras. A variety of methods for camera shake correction are proposed, one among which is restoration-based camera shake correction.

In restoration-based camera shake correction, degradation of an image due to blur is eliminated by restoration processing. For example, based on the image data of one or more shot images, or based on detection data from a camera shake detection sensor, camera shake information—information representing the condition of camera shake during shooting—is estimated (in the form of a point spread function or the like); then, from the camera shake information and the blurry images, a restored image without blur is generated by restoration processing.

In a conventional method of restoration-based camera shake correction, a first image shot with a short exposure time and a second image shot with a long exposure time are acquired consecutively, and, through spatial frequency analysis of the two images, the blur in the second image is corrected. However, since the calculation for eliminating the blur requires considerable time (e.g. one to several seconds), performing the calculation every time shooting is requested at the press of the shutter release button imposes too heavy a load in terms of time.

To avoid that, at the time of shooting, the two images may simply be recorded so that, at the time of playback, they may be read out at the user's request and the blur in the second image corrected, as in a possible alternative method. However, this method requires that two images (the first and second images) be recorded on a recording medium, and thus requires twice as much recording capacity as otherwise.

On the other hand, a blurry image can be regarded as being obtained as a result of an ideal image—an image unaffected by camera shake—being acted upon by a degradation (convolution) function. This means that, by making a restoration (deconvolution) function—one corresponding to the inverse function of the degradation function—act upon an actually obtained blurry image, it is possible to obtain a restored image with the blur eliminated or reduced.

With that taken into consideration, at the time of shooting, detection data from a camera shake detection sensor—based on which data a degradation function can be found—, or a degradation function itself, may be recorded on a recording medium so that, at the time of playback, restoration processing may be performed by use of a restoration function generated from the detected data or the degradation function, as in another conventionally proposed method. However, this method requires that, every time playback occurs, a restoration function be derived from detection data from the sensor, or from the degradation function Since the calculation for the derivation requires considerable time (e.g. one to several seconds), playback takes time accordingly.

Also proposed is restoration-based camera shake correction employing Fourier iteration. FIG. 23 shows a block diagram of a configuration for realizing Fourier iteration. In Fourier iteration, through iterative execution of Fourier and inverse Fourier transforms by way of modification of a restored (deconvolved) image and a point spread function (PSF), the definitive restored image is estimated from a degraded (convolved) image. To execute Fourier iteration, an initial restored image (the initial value of a restored image) needs to be given. Typically used as the initial restored image is a random image, or a degraded image as a blurry image.

### SUMMARY OF THE INVENTION

According to one aspect of the present invention, an image recording apparatus for acquiring a main image from an image sensing portion and recording the main image on a recording medium, the image recording apparatus is provided with: an image acquirer that acquires, when acquiring the main image from the image sensing portion, also a short-exposure image shot with an exposure time shorter than the exposure time of the main image; a partial image cutter that cuts out a partial image from the short-exposure image; and a recording controller that records, on the recording medium, in association with the main image, a sub image obtained from the partial image, along with the cut-out position of the partial image.

For example, the image recording apparatus may be further provided with: an image processor that applies predetermined image processing on the partial image cut out by the partial image cutter. Here, the recording controller records, on the recording medium, as the sub image, the partial image having undergone the image processing.

For example, the short-exposure image may include first and second reference images, the partial image cutter may cut out a partial image from each of the reference images, and the sub image may be obtained by performing weighted addition on the partial images of the first and second reference images.

For example, the short-exposure image may include first and second reference images, the partial image cutter may cut out a partial image from each of the reference images, and the sub image may be obtained from the partial image of the first reference image or the partial image of the second reference image.

According to another aspect of the present invention, an image correcting apparatus is provided with: a read-out controller that reads out the sub image and the cut-out position from the recording medium; and a corrector that corrects the main image recorded on the recording medium based on the contents read out by the read-out controller.

Specifically, for example, the corrector may cut out a partial image from the main image based on the cut-out position read out, and correct the main image based on a partial image of the main image and the sub image.

More specifically, for example, the corrector may be provided with a restoration function generator that estimates the condition of degradation in the main image due to blur and that generates a restoration function for correcting the degradation. Here, the corrector corrects the degradation of the main image by making the restoration function act upon the main image.

According to yet another aspect of the present invention, an image sensing apparatus is provided with the image recording apparatus and the image sensing portion described anywhere above.

According to yet another aspect of the present invention, an image recording method for acquiring a main image from an image sensing portion and recording the main image on a recording medium, the image recording method includes: an image acquisition step of acquiring, when acquiring the main image from the image sensing portion, also a short-exposure image shot with an exposure time shorter than the exposure time of the main image; a partial image cutting step of cutting out a partial image from the short-exposure image; and a recording control step of recording, on the recording medium, in association with the main image, a sub image obtained from the partial image, along with a cut-out position of the partial image.

According to yet another aspect of the present invention, an image recording apparatus for acquiring an original image from an image sensing portion and recording the original image on a recording medium is provided with: an image acquirer that acquires, when acquiring the original image from the image sensing portion, also a reference image shot with an exposure time shorter than the exposure time of the original image; a restoration function generator that generates, based on the original image and the reference image, a restoration function for correcting degradation in the original image due to blur; and a recording controller that records, on the recording medium, in association with the original image, restoration function data representing the restoration function.

According to yet another aspect of the present invention, an image recording apparatus for acquiring an original image from an image sensing portion and recording the original image on a recording medium is provided with: a degradation function generator that generates a degradation function representing the condition of degradation in the original image due to blur; a restoration function generator that generates, from the degradation function, a restoration function for correcting the degradation; and a recording controller that records, on the recording medium, in association with the original image, restoration function data representing the restoration function.

Specifically, for example, the restoration function may be represented by a two-dimensional FIR filter.

For example, the recording controller may record, on the recording medium, as the restoration function data, the filter size of and the filter coefficients of the two-dimensional FIR filter.

For example, the recording controller may be provided with a compressor that compresses the filter coefficients, so that the recording controller records, on the recording medium, as the restoration function data, the filter size, the compressed filter coefficients, and data representing the compression method of the filter coefficients.

According to yet another aspect of the present invention, an image correcting apparatus is provided with: a restoration function reader that reads out the restoration function data from the recording medium; and a corrector that corrects, by using the restoration function data read out, degradation in the original image recorded on the recording medium.

According to yet another aspect of the present invention, an image sensing apparatus is provided with the image recording apparatus and the image sensing portion described anywhere above.

According to yet another aspect of the present invention, an image recording method for acquiring an original image from an image sensing portion and recording the original image on a recording medium includes: an image acquisition step of acquiring, when acquiring the original image from the image sensing portion, also a reference image shot with an exposure time shorter than the exposure time of the original image; a restoration function generation step of generating, based on the original image and the reference image, a restoration function for correcting degradation in the original image due to blur; and a restoration function recording step of recording, on the recording medium, in association with the original image, restoration function data representing the restoration function.

According to yet another aspect of the present invention, an image recording method for acquiring an original image from an image sensing portion and recording the original image on a recording medium includes: a degradation function generation step of generating a degradation function representing the condition of degradation in the original image due to blur; a restoration function generation step of generating, from the degradation function, a restoration function for correcting the degradation; and a restoration function recording step of recording, on the recording medium, in association with the original image, restoration function data representing the restoration function.

The significance and benefits of the invention will be clear from the following description of its embodiments. It should however be understood that these embodiments are merely examples of how the invention is implemented, and that the meanings of the terms used to describe the invention and its features are not limited to the specific ones in which they are used in the description of the embodiments.

### BRIEF DESCRIPTION OF THE DRAWINGS

FIG. 1 is an overall block diagram of an image sensing apparatus embodying the invention;

FIG. 2 is a flow chart showing the flow of operations for camera shake detection and camera shake correction according to a first example of processing in a first embodiment of the invention;

FIG. 3 is a conceptual diagram showing part of the flow of operations in FIG. 2;

FIG. 4 is a flow chart showing the details of the Fourier iteration in FIG. 2;

FIG. 5 is a block diagram of a configuration for realizing the Fourier iteration in FIG. 2;

FIG. 6 is a flow chart showing the flow of operations for camera shake detection and camera shake correction according to a second example of processing in the first embodiment of the invention;

FIG. 7 is a conceptual diagram showing part of the flow of operations in FIG. 6;

FIG. 8 is a diagram illustrating the processing for vertical and horizontal enlargement of the filter coefficients of an image restoration filter as executed in the second example of processing;

FIG. 9 is a flow chart showing the flow of operations for camera shake detection and camera shake correction according to a third example of processing in the first embodiment of the invention;

FIG. 10 is a conceptual diagram showing part of the flow of operations in FIG. 9;

FIGS. 11A and 11B are diagrams illustrating the significance of the processing for weighted addition as executed in the third example of processing;

FIG. 12 is a flow chart showing the flow of operations for camera shake detection and camera shake correction according to a fourth example of processing in the first embodiment of the invention;

FIG. 13 is a conceptual diagram showing part of the flow of operations in FIG. 12;

FIG. 14 is a block diagram showing the configuration of the blocks related to shooting provided in the image sensing apparatus of FIG. 1 in a second embodiment of the invention;

FIG. 15 is a block diagram showing the configuration of the blocks related to playback provided in the image sensing apparatus of FIG. 1 in the second embodiment of the invention;

FIG. 16 is a flow chart showing the operation procedure of the blocks shown in FIG. 14;

FIG. 17 is a flow chart showing the operation procedure of the blocks shown in FIG. 15;

FIG. 18 is a diagram showing the structure of an image file saved on the recording medium in FIG. 1;

FIG. 19 is a diagram illustrating small image cut-out position data;

FIG. 20 is a block diagram showing a modified example of the configuration of FIG. 14;

FIG. 21 is a diagram showing how the entire region of each of a correction target image and a reference image is divided into nine partial regions in a third embodiment of the invention;

FIG. 22 is a diagram showing how the entire region of a reference image is divided into a plurality of partial regions in the third embodiment of the invention;

FIG. 23 is a block diagram showing a conventional configuration for realizing Fourier iteration;

FIG. 24 is a block diagram showing the blocks related to shooting provided in the image sensing apparatus of FIG. 1 in a fourth embodiment of the invention;

FIG. 25 is a flow chart showing the operation procedure of the blocks shown in FIG. 24;

FIG. 26 is a block diagram showing the blocks related to playback provided in the image sensing apparatus of FIG. 1 in the fourth embodiment of the invention;

FIG. 27 is a flow chart showing the operation procedure of the blocks shown in FIG. 26;

FIG. 28 is a diagram showing the relationship among an ideal image, a correction target image as a blurry image, and a corrected image in the fourth embodiment of the invention;

FIG. 29 is a diagram showing an image restoration filer representing a restoration function in the fourth embodiment of the invention;

FIGS. 30A and 30B are diagrams showing the data structure of the header region of image files in the fourth embodiment of the invention;

FIG. 31 is a diagram showing how the entire region of a correction target image is divided into a plurality of partial regions in the fourth embodiment of the invention

FIG. 32 is a block diagram showing the blocks related to shooting provided in the image sensing apparatus of FIG. 1 in a fifth embodiment of the invention; and

FIG. 33 is a flow chart showing the operation procedure of the blocks shown in FIG. 32.

### DETAILED DESCRIPTION OF PREFERRED EMBODIMENTS

Hereinafter, embodiments of the present invention will be described specifically with respect to the accompanying drawings. Among the different drawings referred to in the course of description, the same parts are identified by the same reference signs, and in principle no overlapping description of the same parts will be repeated.

The distinctive technology with which the present invention addresses the previously mentioned inconveniences associated with the conventional technology will be described mainly in connection with a second to a sixth embodiment; before that, first, for the sake of convenience of description, the technical features employed in the second to sixth embodiments will be described in connection with a first embodiment.

### First Embodiment

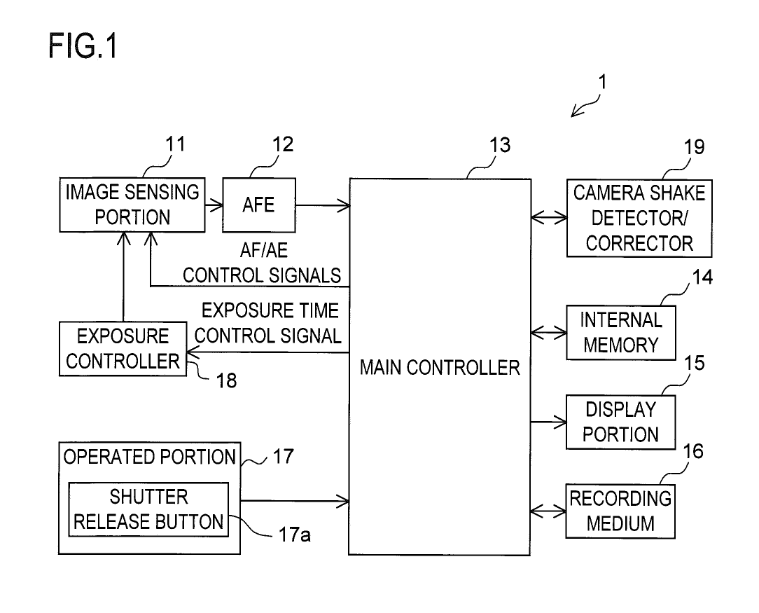

A first embodiment of the invention will be described below. FIG. 1 is an overall block diagram of an image sensing apparatus 1 according to the first embodiment of the invention. The image sensing apparatus 1 of FIG. 1 is a digital still camera capable of shooting and recording still images, or a digital video camera capable of shooting and recording still and moving images.

First, a description will be given of the overall configuration of the image sensing apparatus 1. The image sensing apparatus 1 is provided with an image sensing portion 11, an AFE (analog front end) 12, a main controller 13, an internal memory 14, a display portion 15, a recording medium 16, an operated portion 17, an exposure controller 18, and a camera shake detector/corrector 19. In the operated portion 17 is provided a shutter release button 17a.

The image sensing portion 11 has (though none of the following is illustrated) an optical system, an aperture stop, an image sensing device such as a CCD (charge-coupled device) or CMOS (complementary metal oxide semiconductor) image sensor, and a driver for controlling the optical system and the aperture stop. Based on AF/AE control signals from the main controller 13, the driver controls the zoom magnification and the focal length of the optical system and the degree of aperture of the aperture stop. An optical image representing the subject is incident, through the optical system and the aperture stop, on the image sensing device, which then photoelectrically converts it and feeds the resulting electric signal out to the AFE 12.

The AFE 12 amplifies the analog signal fed out from the image sensing portion 11 (image sensing device), and converts the amplified analog signal into a digital signal. The AFE 12 then sequentially feeds the digital signal out to the main controller 13.

The main controller 13 is provided with a CPU (central processing unit), a ROM (read-only memory), a RAM (random-access memory), etc, and functions also as a video signal processor. Based on the output signal of the AFE 12, the main controller 13 generates a video signal representing the image (hereinafter referred to also as the “shot image”) shot by the image sensing portion 11. The main controller 13 is also furnished to function as a display controller for controlling the contents displayed on the display portion 15, and controls the display portion 15 as necessary to achieve display.

The internal memory 14 is formed with an SDRAM (synchronous dynamic random-access memory) or the like, and temporarily memorizes various kinds of data, including the image data of the shot image, generated within the image sensing apparatus 1. The display portion 15 is a display device built with a liquid crystal display panel or the like, and displays, under the control of the main controller 13, the image shot in the immediately previous frame, an image recorded on the recording medium 16, etc. The recording medium 16 is a non-volatile memory such as an SD (Secure Digital) memory card, and memorizes, under the control of the main controller 13, the shot image etc.

The operated portion 17 accepts operations from outside. The contents of an operation on the operated portion 17 are fed to the main controller 13. The shutter release button 17a is the button operated to request the shooting and recording of a still image.

The exposure controller 18 optimizes the exposure of the image sensing device of the image sensing portion 11 by controlling the exposure time of each pixel of the image sensing device. In a case where the main controller 13 feeds the exposure controller 18 with an exposure time control signal, the exposure controller 18 controls the exposure time according to the exposure time control signal.

The image sensing apparatus 1 operates in different modes including shooting mode, in which it can shoot and record still or moving images, and playback mode, in which it can play back and display on the display portion 15 still or moving images recorded on the recording medium 16. As the operated portion 17 is operated appropriately, the different modes are switched.

In shooting mode, the image sensing portion 11 performs shooting sequentially at a predetermined frame period (e.g. 1/60 seconds). The main controller 13 generates a through-display image from the output of the image sensing portion 11 in each frame, and displays one through-display image thus obtained after another on the display portion 15 in a constantly updated fashion.

In shooting mode, when the shutter release button 17a is pressed, the main controller 13 stores image data representing one shot image (i.e. gets it memorized) on the recording medium 16. This shot image may contain blur due to camera shake, and will later be corrected by the camera shake detector/corrector 19 either in response to a request for correction entered via the operated portion 17 or the like or automatically. Accordingly, such one shot image acquired at the press of the shutter release button 17a is, in particular, called a “correction target image”. In the present specification, the expression “to acquire, save, store, or record (memorize) an image” is synonymous with “to acquire, save, store, or record (memorize) the image data of an image”.

The camera shake detector/corrector 19 detects and corrects camera shake. Specifically, it detects blur contained in a correction target image, and according to the result of the detection corrects the correction target image, thereby to generate a corrected image with the blur eliminated or reduced. In the present specification, “elimination” of blur or degradation does not necessarily mean complete elimination of it, but is to be understood to conceptually cover elimination of part of blur or degradation. Accordingly, for example, the expression “to eliminate blur” may be read as “to eliminate or reduce blur”.

Next, the processing for the detection and correction of camera shake will be described in detail. Presented below as examples of the processing for camera shake detection and camera shake correction will be a first to a fourth example of processing. Unless inconsistent, any description given in connection with one example of processing applies to any other. In the description of the first to fourth examples of processing, the “memory” in which images etc. are memorized is to be understood to denote the internal memory 14 or an unillustrated memory provided within the camera shake detector/corrector 19.

### First Example of Processing

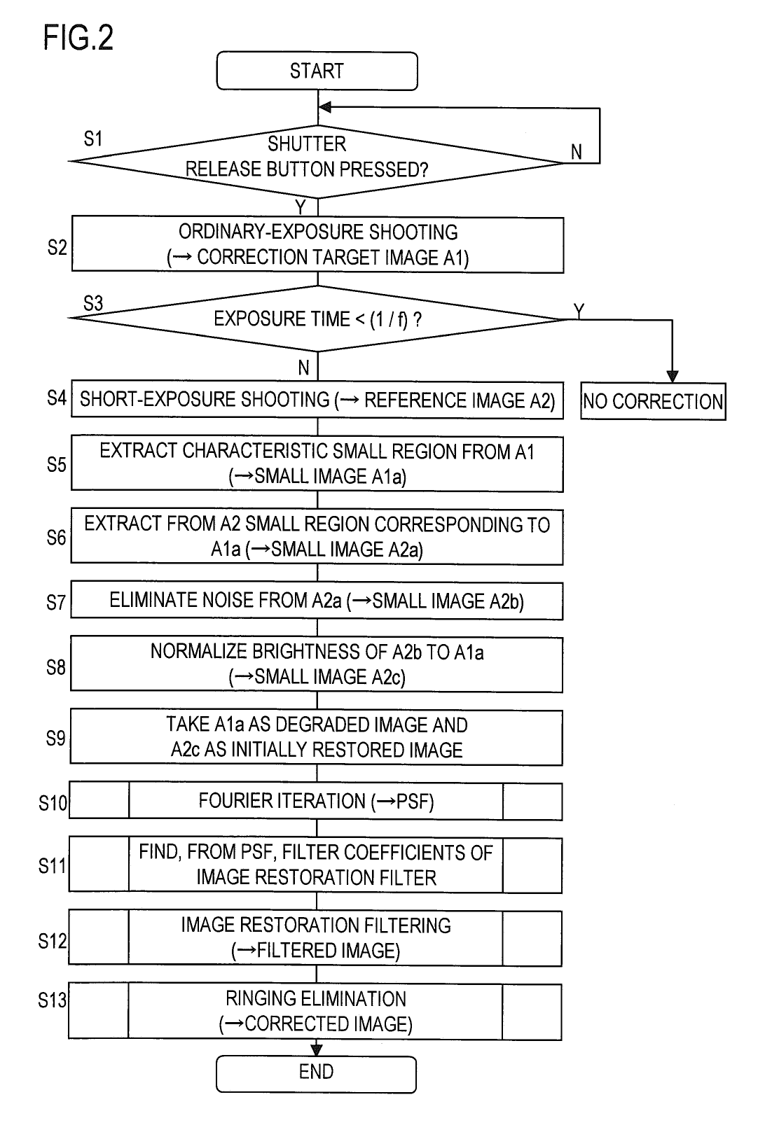

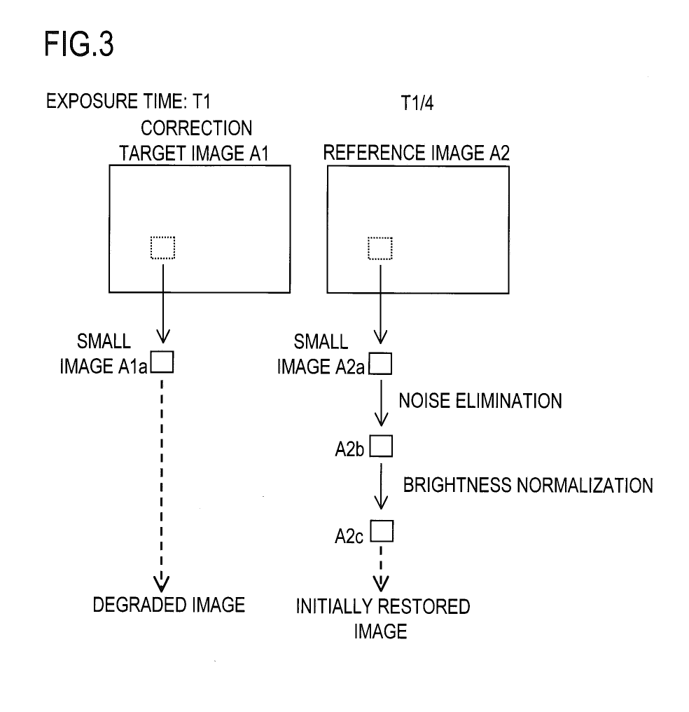

First, a first example of processing will be described. FIGS. 2 and 3 will be referred to. FIG. 2 is a flow chart showing the flow of operations for camera shake detection and camera shake correction according to first example of processing. FIG. 3 is a conceptual diagram showing part of the flow of operations. This flow of operations will now be described according to the flow chart of FIG. 2.

In shooting mode, when the shutter release button 17a is pressed, ordinary-exposure shooting is performed, and the correction target image generated as a result is memorized on the memory (steps S1 and S2). The correction target image in the first example of processing will henceforth be called the correction target image A1.

Next, in step S3, the exposure time T1 with which the correction target image A1 was obtained is compared with a threshold value T_{TH}. If the exposure time T1 is less than the threshold value T_{TH}, it is judged that the correction target image contains no (or very little) blur due to camera shake, and the processing of FIG. 2 is ended without performing camera shake correction. Used as the threshold value T_{TH} is, for example, the camera shake limit exposure time. The camera shake limit exposure time is the limit of the exposure time within which it is believed that camera shake can be ignored, and is calculated from the reciprocal of the focal length f.

If the exposure time T1 is greater than the threshold value T_{TH}, then, in step S4, short-exposure shooting is performed to follow the ordinary-exposure shooting, and the shot image obtained as a result of the short-exposure shooting is, as a reference image, memorized on the memory. The reference image in the first example of processing will henceforth be called the reference image A2. The correction target image A1 and the reference image A2 are obtained by consecutive shooting (i.e. in consecutive frames); here the main controller 13 controls the exposure controller 18 in FIG. 1 such that the exposure time with which the reference image A2 is obtained is shorter than the exposure time T1. For example, the exposure time of the reference image A2 is set at T1/4. The image size of the correction target image A1 is equal to that of the reference image A2.

Next, in step S5, a characteristic small region is extracted from the correction target image A1, and the image inside the extracted small region is, as a small image Ala, memorized on the memory. Here “characteristic small region” denotes a rectangular region in the extraction source image which contains a relatively large edge component (in other words, which has a relatively high contrast ratio); for example, by use of the Harris corner detector, a small region of 128×128 pixels is extracted as a characteristic small region. In this way, a characteristic small region is selected based on the magnitude of the edge component (or contrast ratio) inside it.

Next, in step S6, a small region at the coordinates identical with those of the small region extracted from the correction target image A1 is extracted from the reference image A2, and the image inside the small region extracted from the reference image A2 is, as a small image A2a, memorized on the memory. The center coordinates of the small region extracted from the correction target image A1 (the center coordinates in the correction target image A1) are equal to the center coordinates of the small region extracted from the reference image A2 (the center coordinates in the reference image A2), and the image size of the correction target image A1 is equal to that of the reference image A2; thus the two small regions have an equal image size.

Since the exposure time of the reference image A2 is relatively short, the small image A2a has a relatively low signal-to-noise ratio (hereinafter referred to as the S/N ratio). Accordingly, in step S7, the small image A2a is subjected to noise elimination. The small image A2a having undergone the noise elimination is referred to as the small image A2b. The noise elimination is achieved by filtering the small image A2a by use of a linear filter (such as a weighted average filter) or a nonlinear filter (such as a median filter).

Since the small image A2b has low brightness, in step S8, the brightness level of the small image A2b is increased. Specifically, for example, brightness normalization processing is performed in which the brightness value of each pixel of the small image A2b is multiplied by a fixed value such that the brightness level of the small image A2b is equal to that of the small image A1a (such that the average brightness of the small image A2b is equal to that of the small image A1a). The small image A2b having its brightness level increased in this way is referred to as the small image A2c.

The small images A1a and A2c obtained as described above are taken as a degraded (convolved) image and an initially restored (deconvolved) image respectively (step S9). Then, in step S10, Fourier iteration is executed to find an image degradation function (in other words, image convolution function).

To execute Fourier iteration, an initial restored image (the initial value of a restored image) needs to be given. This initial restored image is called the initially restored image.

As the image degradation function, a point spread function (hereinafter referred to as a PSF) is found. An operator, or spatial filter, that is weighted according to the locus described by an ideal point image in an image as a result of camera shake in the image sensing apparatus 1 is called a PSF, and is commonly used as a mathematical model of camera shake. Since camera shake degrades an entire image uniformly, the PSF found for the small image Ala can be used as the PSF for the entire correction target image A1.

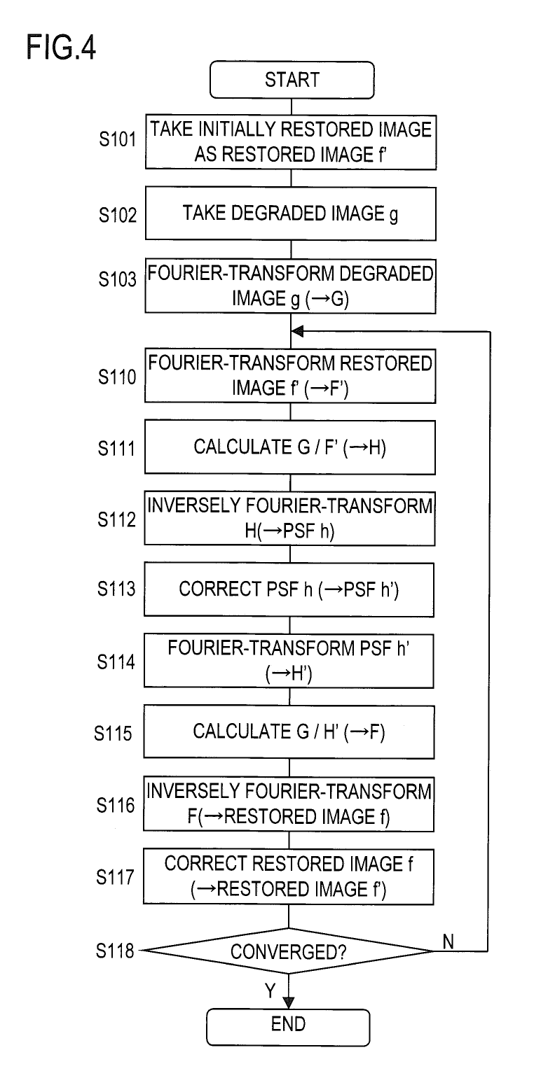

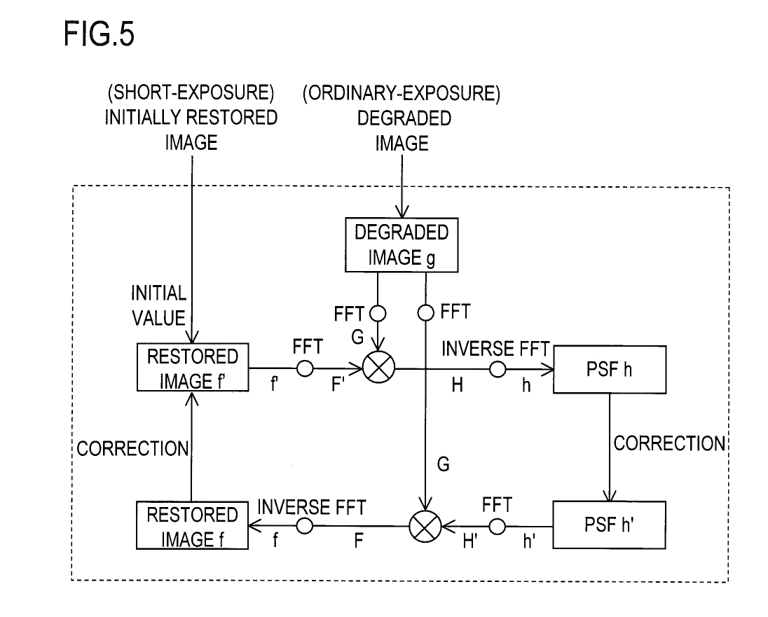

Fourier iteration is a method for obtaining, from a degraded (convolved) image—an image containing degradation—, a restored (deconvolved) image—an image having the degradation eliminated or reduced (see, for example, the following publication: G. R. Ayers and J. C. Dainty, “Iterative blind deconvolution method and its applications”, OPTICS LETTERS, 1988, Vol. 13, No. 7, pp. 547-549). Now, Fourier iteration will be described in detail with reference to FIGS. 4 and 5. FIG. 4 is a detailed flow chart of the processing in step S10 in FIG. 2. FIG. 5 is a block diagram of the blocks that execute Fourier iteration.

First, in step S101, the restored image is represented by f′, and the initially restored image is taken as the restored image f′. That is, as the initial restored image f′, the above-mentioned initially restored image (in this example of processing, the small image A2c) is used. Next, in step S102, the degraded image (in this example of processing, the small image Ala) is taken as g. Then, the degraded image g is Fourier-transformed, and the result is, as G, memorized in the memory (step S103). For example, in a case where the initially restored image and the degraded image have a size of 128×128 pixels, f′, and g are expressed as matrices each of an 128×128 array.

Next, in step S110, the restored image f′ is Fourier-transformed to find F′, and then, in step S111, H is calculated according to formula (1) below. H corresponds to the Fourier-transformed result of the PSF. In formula (1), F′* is the conjugate complex matrix of F′, and α is a constant.

$$H = \frac{G \cdot {F}^{′ *}}{{\vert {F}^{′} \vert}^{2} + α} \qquad ( 1 )$$

Next, in step S112, H is inversely Fourier-transformed to obtain the PSF. The obtained PSF is taken as h. Next, in step S113, the PSF h is corrected according to the restricting condition given by formula (2a) below, and the result is further corrected according to the restricting condition given by formula (2b) below.

$$\begin{matrix}h ( x , y ) = \{ \begin{matrix}1 \text{:} & h ( x , y ) > 1 \\ h ( x , y ) \text{:} & 0 \leq h ( x , y ) \leq 1 \\ 0 \text{:} & h ( x , y ) < 0\end{matrix} & ( 2 a ) \\ \sum h ( x , y ) = 1 & ( 2 b )\end{matrix}$$

The PSF h is expressed as a two-dimensional matrix, of which the elements are represented by h(x, y). Each element of the PSF should inherently take a value of 0 or more but 1 or less. Accordingly, in step S113, whether or not each element of the PSF is 0 or more but 1 or less is checked and, while any element that is 0 or more but 1 or less is left intact, any element more than 1 is corrected to be equal to 1 and any element less than 0 is corrected to be equal to 0. This is the correction according to the restricting condition given by formula (2a). Then, the corrected PSF is normalized such that the sum of all its elements equals 1. This normalization is the correction according to the restricting condition given by formula (2b).

The PSF as corrected according to formulae (2a) and (2b) is taken as h′.

Next, in step S114, the PSF h′ is Fourier-transformed to find H′, and then, in step S115, F is calculated according to formula (3) below. F corresponds to the Fourier-transformed result of the restored image f. In formula (3), H′* is the conjugate complex matrix of H′, and β is a constant.

$$F = \frac{G \cdot {H}^{′ *}}{{\vert {H}^{′} \vert}^{2} + β} \qquad ( 3 )$$

Next, in step S116, F is inversely Fourier-transformed to obtain the restored image. The obtained restored image is taken as f. Next, in step S117, the restored image f is corrected according to the restricting condition given by formula (4) below, and the corrected restored image is newly taken as f′.

$$f ( x , y ) = \{ \begin{matrix}255 \text{:} & f ( x , y ) > 255 \\ f ( x , y ) \text{:} & 0 \leq f ( x , y ) \leq 255 \\ 0 \text{:} & f ( x , y ) < 0\end{matrix} \qquad ( 4 )$$

The restored image f is expressed as a two-dimensional matrix, of which the elements are represented by f(x, y). Assume here that the value of each pixel of the degraded image and the restored image is represented as a digital value of 0 to 255. Then, each element of the matrix representing the restored image f (i.e. the value of each pixel) should inherently take a value of 0 or more but 255 or less. Accordingly, in step S117, whether or not each element of the matrix representing the restored image f is 0 or more but 255 or less is checked and, while any element that is 0 or more but 255 or less is left intact, any element more than 255 is corrected to be equal to 255 and any element less than 0 is corrected to be equal to 0. This is the correction according to the restricting condition given by formula (4).

Next, in step S118, whether or not a convergence condition is fulfilled is checked and thereby whether or not the iteration has converged is checked.

For example, the absolute value of the difference between the newest F′ and the immediately previous F′ is used as an index for the convergence check. If this index is equal to or less than a predetermined threshold value, it is judged that the convergence condition is fulfilled; otherwise, it is judged that the convergence condition is not fulfilled.

If the convergence condition is fulfilled, the newest H′ is inversely Fourier-transformed, and the result is taken as the definitive PSF. That is, the inversely Fourier-transformed result of the newest H′ is the PSF that is to be eventually found in step S10 in FIG. 2. If the convergence condition is not fulfilled, the flow returns to step S110 to repeat the processing in steps S110 to S118. As the processing in steps S110 to S118 is repeated, the functions f, F′, H, h, h′, H′, F, and f (see FIG. 5) are sequentially updated to be the newest.

As the index for the convergence check, any other index may be used. For example, the absolute value of the difference between the newest H′ and the immediately previous H′ may be used as an index for the convergence check with reference to which to check whether or not the above-mentioned convergence condition is fulfilled. Instead, the amount of correction made in step S113 according to formulae (2a) and (2b) above, or the amount of correction made in step S117 according to formula (4) above, may be used as the index for the convergence check with reference to which to check whether or not the above-mentioned convergence condition is fulfilled. This is because, as the iteration converges, those amounts of correction decrease.

If the number of times of repetition of the loop processing through steps S110 to S118 has reached a predetermined number, it may be judged that convergence is impossible and the processing may be ended without calculating the definitive PSF. In this case, the correction target image is not corrected.

Back in FIG. 2, after the PSF is calculated in step S10, the flow proceeds to step S11. In step S11, the elements of the inverse matrix of the PSF calculated in step S10 are found as the filter coefficients of the image restoration filter (in other words, image deconvolution filter). This image restoration filter is a filter for obtaining the restored image from the degraded image. In practice, the elements of the matrix expressed by formula (5) below, which corresponds to part of the right side of formula (3) above, correspond to the filter coefficients of the image restoration filter, and therefore an intermediary result of the Fourier iteration calculation in step S10 can be used intact. What should be noted here is that H′* and H′ in formula (5) are H′* and H′ as obtained immediately before the fulfillment of the convergence condition in step S118 (i.e. H′* and H′ as definitively obtained).

$$\frac{{H}^{′ *}}{{\vert {H}^{′} \vert}^{2} + β} \qquad ( 5 )$$

After the filter coefficients of the image restoration filter are found in step S11, then, in step S12, the correction target image A1 is filtered by use of the image restoration filter to generate a filtered image in which the blur contained in the correction target image A1 has been eliminated or reduced. The filtered image may contain ringing ascribable to the filtering, and thus then, in step S13, the ringing is eliminated to generate the definitive corrected image.

### Second Example of Processing

Next, a second example of processing will be described.

As described above, in shooting mode, the image sensing portion 11 performs shooting sequentially at a predetermined frame period (e.g. 1/60 seconds), and the main controller 13 generates a through-display image from the output of the image sensing portion 11 in each frame and displays one through-display image thus obtained after another on the display portion 15 in a constantly updated fashion.

The through-display image is an image for a moving image, and its image size is smaller than that of the correction target image, which is a still image. Whereas the correction target image is generated from the pixel signals of all the pixels in the effective image-sensing region of the image sensor provided in the image-sensing portion 11, the through-display image is generated from the pixel signals of thinned-out part of the pixels in the effective image-sensing region. In a case where the shot image is generated from the pixel signals of all the pixels in the effective image-sensing region, the correction target image is nothing but the shot image itself that is shot by ordinary exposure and recorded at the press of the shutter release button 17a, while the through-display image is a thinned-out image of the shot image of a given frame.

In the second example of processing, the through-display image based on the shot image of the frame immediately before or after the frame in which the correction target image is shot is used as a reference image. The following description deals with, as an example, a case where the through-display image of the frame immediately before the frame in which the correction target image is shot is used.

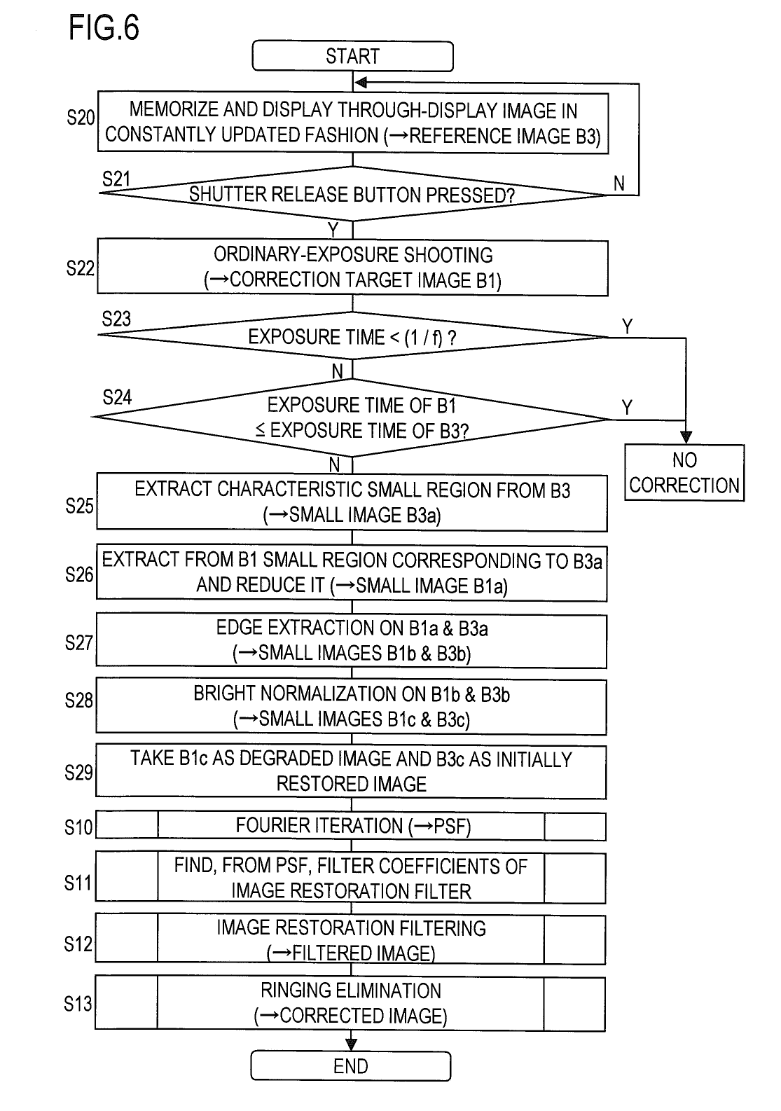

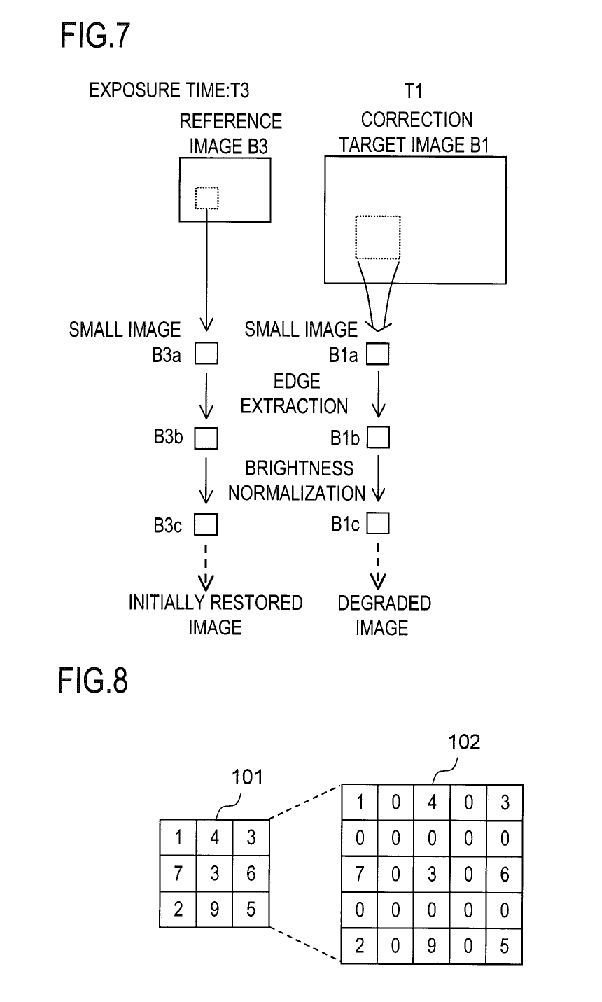

FIGS. 6 and 7 will be referred to. FIG. 6 is a flow chart showing the flow of operations for camera shake detection and camera shake correction according to the second example of processing, and FIG. 7 is a conceptual diagram showing part of the flow of operations. This flow of operations will now be described according to the flow chart of FIG. 6.

In shooting mode, as described above, a through-display image is generated in each frame so that one through-display image after another is memorized on the memory in a constantly updated fashion and displayed on the display portion 15 in a constantly updated fashion (step S20). When the shutter release button 17a is pressed, ordinary-exposure shooting is performed, and the correction target image generated as a result is memorized (steps S21 and S22). The correction target image in the second example of processing will henceforth be called the correction target image B1. The through-display image memorized on the memory at this point is that obtained by the shooting of the frame immediately before the frame in which the correction target image B1 is shot, and this through-display image will henceforth be called the reference image B3.

Next, in step S23, the exposure time T1 with which the correction target image B1 was obtained is compared with a threshold value T_{TH}. If the exposure time T1 is less than the threshold value T_{TH} (e.g. the reciprocal of the focal length f), it is judged that the correction target image contains no (or very little) blur attributable to camera shake, and the processing of FIG. 6 is ended without performing camera shake correction.

If the exposure time T1 is greater than the threshold value T_{TH}, then, in step S24, the exposure time T1 is compared with the exposure time T3 with which the reference image B3 was obtained. If T1≦T3, it is judged that the reference image B3 contains more camera shake, and the processing of FIG. 6 is ended without performing camera shake correction. If T1>T3, then, in step S25, by use of the Harris corner detector or the like, a characteristic small region is extracted from the reference image B3, and the image inside the extracted small region is, as a small image B3a, memorized on the memory. The significance of and the method for extracting a characteristic small region are similar to those described in connection with the first example of processing.

Next, in step S26, a small region corresponding to the coordinates of the small image B3a is extracted from the correction target image B1. Then the image inside the small region extracted from the correction target image B1 is reduced in the image size ratio of the correction target image B1 to the reference image B3, and the resulting image is, as a small image B1a, memorized on the memory. That is, when the small image B1a is generated, its image size is normalized such that the small images B1a and B3a have an equal image size.

If the reference image B3 is enlarged such that the correction target image B1 and the reference image B3 have an equal image size, the center coordinates of the small region extracted from the correction target image B1 (the center coordinates in the correction target image B1) are equal to the center coordinates of the small region extracted from the reference image B3 (the center coordinates in the reference image B3). In reality, however, the correction target image B1 and the reference image B3 have different image sizes, and accordingly the image sizes of the two small regions differ in the image size ratio of the correction target image B1 to the reference image B3. Thus the image size ratio of the small region extracted from the correction target image B1 to the small region extracted from the reference image B3 is made equal to the image size ratio of the correction target image B1 to the reference image B3. Eventually, by reducing the image inside the small region extracted from the correction target image B1 such that the small images B1a and B3a have equal image sizes, the small image B1a is obtained.

Next, in step S27, the small images B1a and B3a are subjected to edge extraction to obtain small images B1b and B3b. For example, an arbitrary edge detection operator is applied to each pixel of the small image B1a to generate an extracted-edge image of the small image B1a, and this extracted-edge image is taken as the small image B1b. The same is done with the small image B3b.

Thereafter, in step S28, the small images B1b and B3b are subjected to brightness normalization. Specifically, the brightness value of each pixel of the small image B1b or B3b or both is multiplied by a fixed value such that the small images B1b and B3b have an equal brightness level (such that the average brightness of the small image B1b is equal to that of the small image B3b). The small images B1b and B3b having undergone the brightness normalization are taken as small images B1c and B3c.

The through-display image taken as the reference image B3 is an image for a moving image, and is therefore obtained through image processing for a moving image—after being so processed as to have a color balance suitable for a moving image. On the other hand, the correction target image B1 is a still image shot at the press of the shutter release button 17a, and is therefore obtained through image processing for a still image. Due to the difference between the two types of image processing, the small images B1a and B3a, even with the same subject, have different color balances. This difference can be eliminated by edge extraction, and this is the reason that edge extraction is performed in step S27. Edge extraction also largely eliminates the difference in brightness between the correction target image B1 and the reference image B3, and thus helps reduce the effect of a difference in brightness (i.e., it helps enhance the accuracy of blur detection); it however does not completely eliminate it, and therefore, thereafter, in step S28, brightness normalization is performed.

The small images B1c and B3c obtained as described above are taken as a degraded image and an initially restored image respectively (step S29). The flow then proceeds to step S10 to execute the processing in steps S10, S11, S12, and S13 sequentially.

The processing in steps S10 to S13 is similar to that in the first example of processing. The difference is that, since the filter coefficients of the image restoration filter obtained through steps S10 and S11 (and the PSF obtained through step S10) are adapted to the image size of a moving image, these are here re-adapted to the image size of a still image by vertical and horizontal enlargement.

For example, in a case where the image size ratio of the through-display image to the correction target image is 3:5 and in addition the size of the image restoration filter obtained through steps S10 and S11 is 3×3, when the calculated filter coefficients are as indicated by 101 in FIG. 8, through vertical and horizontal enlargement, the filter coefficients of an image restoration filter having a size of 5×5 as indicated by 102 in FIG. 8 are generated. Eventually, the filter coefficients of the 5×5-size image restoration filter are taken as the filter coefficients obtained in step S11. In the example indicated by 102 in FIG. 8, those filter coefficients which are interpolated by vertical and horizontal enlargement are given the value of 0; instead, they may be given values calculated by linear interpolation or the like.

After the filter coefficients of the image restoration filter are found in step S11, then, in step S12, the correction target image B1 is filtered by use of this image restoration filter to generate a filtered image in which the blur contained in the correction target image B1 has been eliminated or reduced. The filtered image may contain ringing ascribable to the filtering, and thus then, in step S13, the ringing is eliminated to generate the definitive corrected image.

### Third Example of Processing

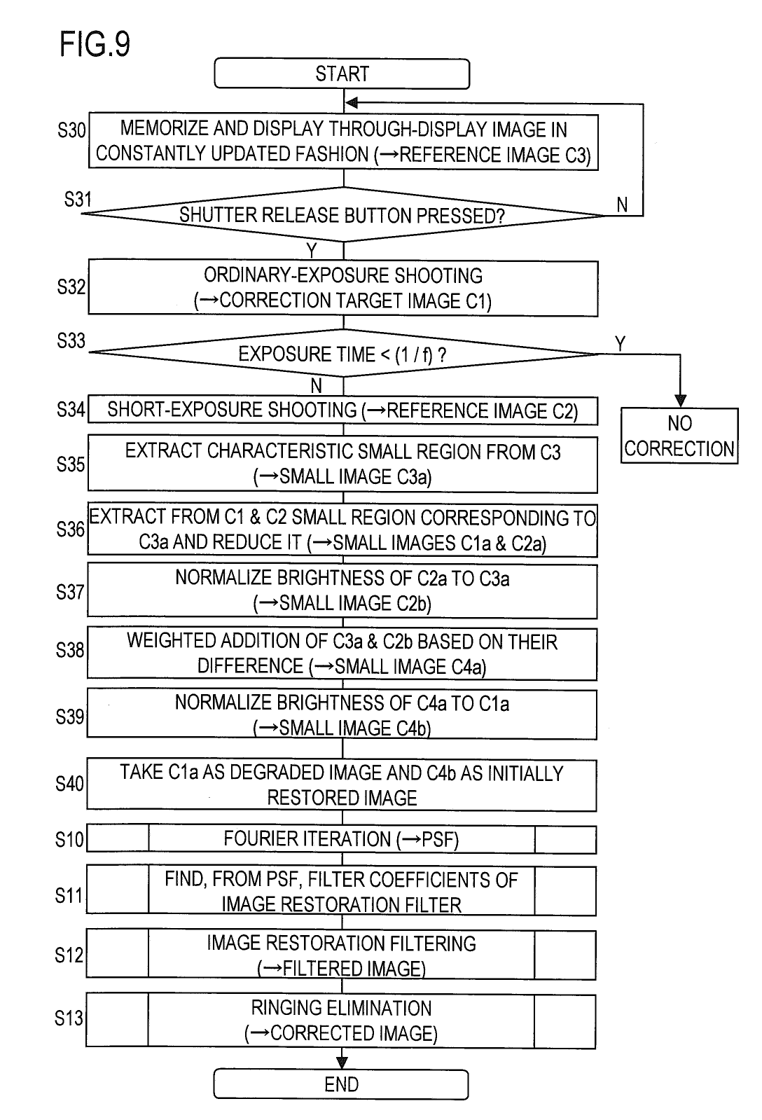

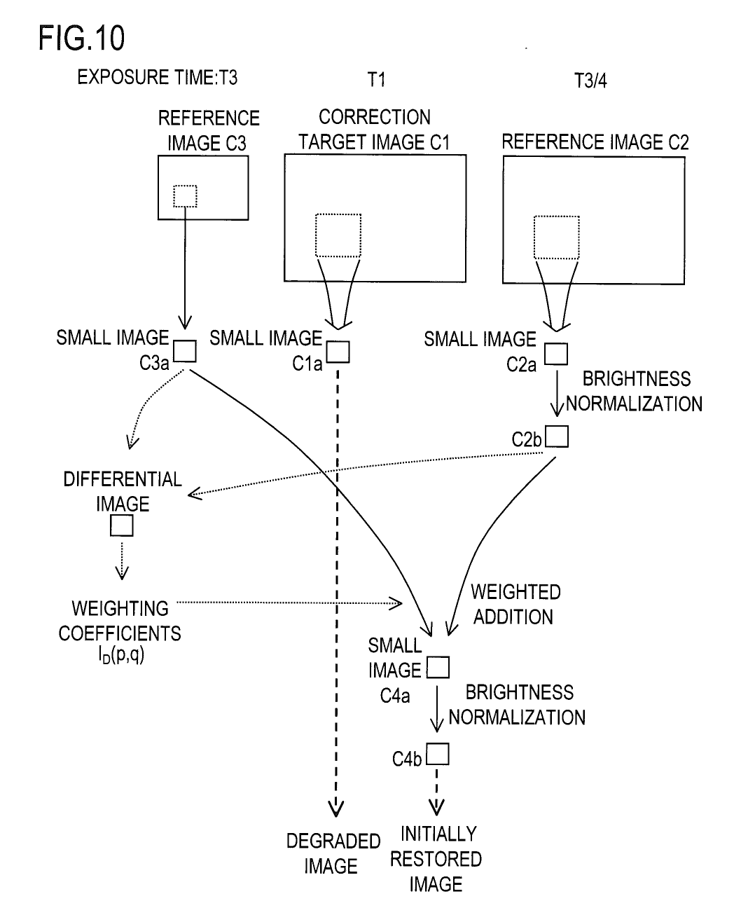

Next, a third example of processing will be described. FIGS. 9 and 10 will be referred to. FIG. 9 is a flow chart showing the flow of operations for camera shake detection and camera shake correction, in connection with the third example of processing, and FIG. 10 is a conceptual diagram showing part of the flow of operations. This flow of operations will now be described according to the flow chart of FIG. 9.

In shooting mode, a through-display image is generated in each frame so that one through-display image after another is memorized on the memory in a constantly updated fashion and displayed on the display portion 15 in a constantly updated fashion (step S30). When the shutter release button 17a is pressed, ordinary-exposure shooting is performed, and the correction target image generated as a result is memorized (steps S31 and S32). The correction target image in the third example of processing will henceforth be called the correction target image C1. The through-display image memorized on the memory at this point is that obtained by the shooting of the frame immediately before the frame in which the correction target image C1 is shot, and this through-display image will henceforth be called the reference image C3.

Next, in step S33, the exposure time T1 with which the correction target image C1 was obtained is compared with a threshold value T_{TH}. If the exposure time T1 is less than the threshold value T_{TH} (e.g. the reciprocal of the focal length f), it is judged that the correction target image contains no (or very little) blur attributable to camera shake, and the processing of FIG. 9 is ended without performing camera shake correction.

If the exposure time T1 is greater than the threshold value T_{TH}, then the exposure time T1 is compared with the exposure time T3 with which the reference image C3 was obtained. If T1≦T3, it is judged that the reference image C3 contains more camera shake, and thereafter camera shake detection and camera shake correction similar to those in the first example of processing are executed (i.e., processing similar to that in steps S4 to S13 in FIG. 2 is performed). By contrast, if T1>T3, then, in step S34, short-exposure shooting is performed to follow the ordinary-exposure shooting, and the shot image obtained as a result is, as a reference image C2, memorized on the memory. In FIG. 9, the processing for comparing T1 and T3 is omitted, and the following description deals with a case where T1>T3.

The correction target image C1 and the reference image C2 are obtained by consecutive shooting (i.e. in consecutive frames); here the main control portion 13 controls the exposure control portion 18 in FIG. 1 such that the exposure time with which the reference image C2 is obtained is shorter than the exposure time T1. For example, the exposure time of the reference image C2 is set at T3/4. The correction target image C1 and the reference image C2 have an equal image size.

After step S34, in step S35, by use of the Harris corner detector or the like, a characteristic small region is extracted from the reference image C3, and the image in the extracted small region is, as a small image C3a, memorized on the memory. The significance of and the method for extracting a characteristic small region are similar to those described in connection with the first example of processing.

Next, in step S36, a small region corresponding to the coordinates of the small image C3a is extracted from the correction target image C1. Then, the image inside the small region extracted from the correction target image C1 is reduced in the image size ratio of the correction target image C1 to the reference image C3, and the resulting image is, as a small image C1a, memorized on the memory. That is, when the small image C1a is generated, its image size is normalized such that the small images C1a and C3a have an equal image size. Likewise, a small region corresponding to the coordinates of the small image C3a is extracted from the reference image C2. Then, the image inside the small region extracted from the reference image C2 is reduced in the image size ratio of the reference image C2 to the reference image C3, and the resulting image is, as a small image C2a, memorized on the memory. The method for obtaining the small image C1a (or the small image C2a) from the correction target image C1 (or the reference image C2) is similar to the method, described in connection with the second example of processing, for obtaining the small image B1a from the correction target image B1 (step S26 in FIG. 6).

Next, in step S37, the small image C2a is subjected to brightness normalization with respect to the small image C3a. That is, the brightness value of each pixel of the small image C2a is multiplied by a fixed value such that the small images C3a and C2a have an equal brightness level (such that the average brightness of the small image C3a is equal to that of the small image C2a). The small image C2a having undergone the brightness normalization is taken as a small image C2b.

After the processing in step S37, the flow proceeds to step S38. In step S38, first, the differential image between the small images C3a and C2b is generated. In the differential image, pixels take a value other than 0 only where the small images C3a and C2b differ from each other. Then, with the value of each pixel of the differential image taken as a weighting coefficient, the small images C3a and C2b are subjected to weighted addition to generate a small image C4a.

When the value of each pixel of the differential image is represented by I_{D}(p, q), the value of each pixel of the small image C3a is represented by I₃(p, q), the value of each pixel of the small image C2b is represented by I₂(p, q), and the value of each pixel of the small image C4a is represented by I₄(p, q), then I₄(p, q) is given by formula (6) below, where k is a constant and p and q are horizontal and vertical coordinates, respectively, in the relevant differential or small image.

I₄(p,q)=k·I_{D}(p,q)·I₂(p,q)+(1−k)·I_{D}(p,q)−I₃(p,q) (6)

As will be clarified in a description given later, the small image C4a is used as an image for calculating the PSF corresponding to the blur in the correction target image C1. To obtain a satisfactory PSF, it is necessary to maintain an edge part appropriately in the small image C4a. Moreover, naturally, the higher the S/N ratio of the small image C4a, the more satisfactory the PSF obtained. Generally, adding up a plurality of images leads to a higher S/N ratio; this is the reason that the small images C3a and C2b are added up to generate the small image C4a. If, however, the addition causes the edge part to blur, it is not possible to obtain a satisfactory PSF.

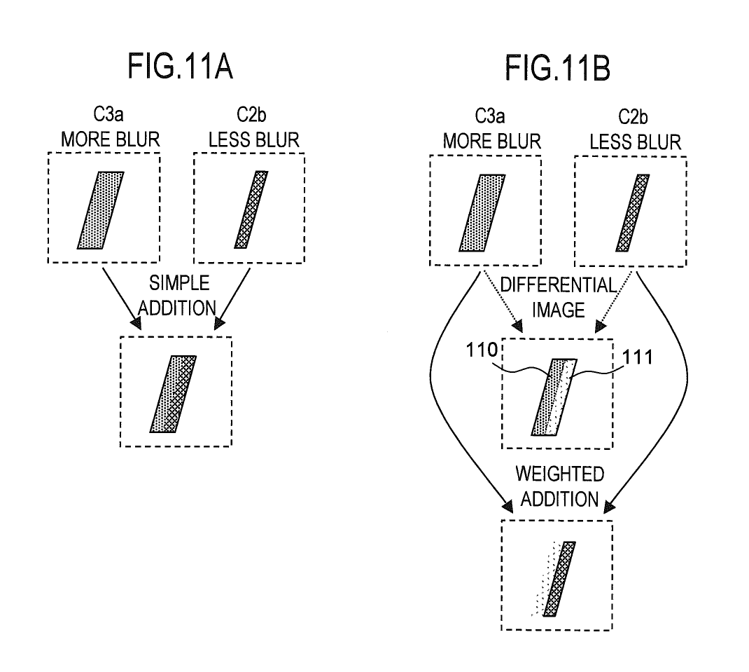

Thus, as described above, the small image C4a is generated by weighted addition according to the pixel values of the differential image. Now, the significance of the weighted addition here will be supplementarily described with reference to FIGS. 11A and 11B. Since the exposure time of the small image C3a is longer than that of the small image C2b, as shown in FIG. 11A, when an identical edge image is shot, more blur occurs in the former than in the latter. Accordingly, if the two small images are simply added up, as shown in FIG. 11A, the edge part blurs; by contrast, as shown in FIG. 11B, if the two small images are subjected to weighted addition according to the pixel values of the differential image between them, the edge part is maintained relatively well. In the different part 110 (where the edge part is differently degraded) that arises due to the small image C3a containing more blur, I_{D}(P, q) are larger, giving more weight to the small image C2b, with the result that the small image C4a reflects less of the large edge-part degradation in the small image C3a. Conversely, in the non-different part 111, more weight is given to the small image C3a, of which the exposure time is relatively long, and this helps increase the S/N ratio (reduce noise).

Next, in step S39, the small image C4a is subjected to brightness normalization with respect to the small image C1a. That is, the brightness value of each pixel of the small image C4a is multiplied by a fixed value such that the small images C1a and C4a have an equal brightness level (such that the average brightness of the small image C1a is equal to that of the small image C4a). The small image C4a having undergone the brightness normalization is taken as a small image C4b.

The small images C1a and C4b obtained as described above are taken as a degraded image and an initially restored image respectively (step S40). The flow then proceeds to step S10 to execute the processing in steps S10, S11, S12, and S13 sequentially.

The processing in steps S10 to S13 is similar to that in the first example of processing. The difference is that, since the filter coefficients of the image restoration filter obtained through steps S10 and S11 (and the PSF obtained through step S10) are adapted to the image size of a moving image, these are here re-adapted to the image size of a still image by vertical and horizontal enlargement. The vertical and horizontal enlargement here is similar to that described in connection with the second example of processing.

After the filter coefficients of the image restoration filter are found in step S11, then, in step S12, the correction target image C1 is filtered by use of this image restoration filter to generate a filtered image in which the blur contained in the correction target image C1 has been eliminated or reduced. The filtered image may contain ringing ascribable to the filtering, and thus then, in step S13, the ringing is eliminated to generate the definitive corrected image.

### Fourth Example of Processing

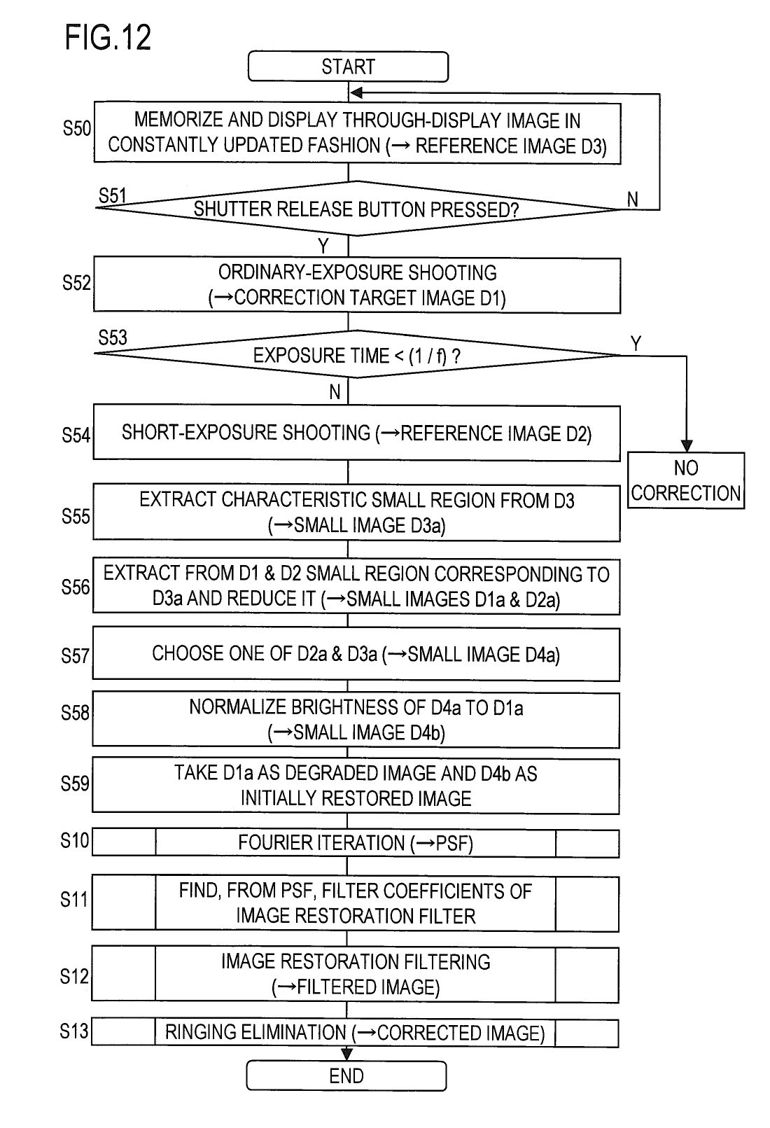

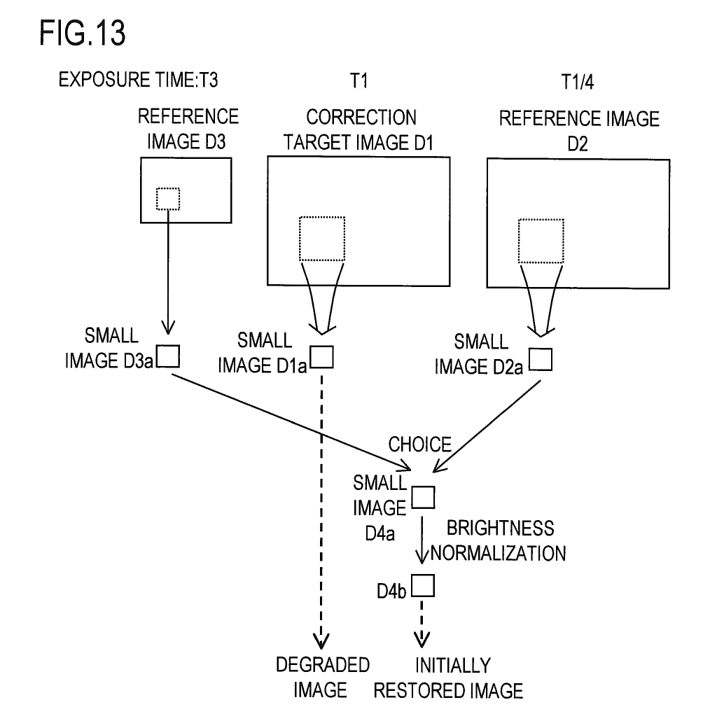

Next, a fourth example of processing will be described. FIGS. 12 and 13 will be referred to. FIG. 12 is a flow chart showing the flow of operations for camera shake detection and camera shake correction according to the fourth example of processing, and FIG. 13 is a conceptual diagram showing part of the flow of operations. This flow of operations will now be described according to the flow chart of FIG. 12.

In the fourth example of processing, first, the processing in steps S50 to S56 is performed. The processing in steps S50 to S56 is similar to that in steps S30 to S36 (see FIG. 9) in the third example of processing, and therefore no overlapping description will be repeated. It should however be noted that the correction target image C1 and the reference images C2 and C3 in the third example of processing are read as a correction target image D1 and reference images D2 and D3 in the fourth example of processing. The exposure time of the reference image D2 is set at, for example, T1/4.

Through steps S50 to S56, small images D1a, D2a, and D3a based on the correction target image D1 and the reference images D2 and D3 are obtained, and then the flow proceeds to step S57.

In step S57, one of the small images D2a and D3a is chosen as a small image D4a. The choice here is made according to one or more of various indices.

For example, the edge intensity of the small image D2a is compared with that of the small image D3a, and whichever has the higher edge intensity is chosen as the small image D4a. The small image D4a will serve as the basis of the initially restored image for Fourier iteration. This is because it is believed that, the higher the edge intensity of an image is, the less its edge part is degraded and thus the more suitable it is as the initially restored image. For example, a predetermined edge extraction operator is applied to each pixel of the small image D2a to generate an extracted-edge image of the small image D2a, and the sum of the all pixel values of this extracted-edge image is taken as the edge intensity of the small image D2a. The edge intensity of the small image D3a is calculated likewise.

Instead, for example, the exposure time of the reference image D2 is compared with that of the reference image D3, and whichever has the shorter exposure time is chosen as the small image D4a. This is because it is believed that, the shorter the exposure time of an image is, the less its edge part is degraded and thus the more suitable it is as the initially restored image. Instead, for example, based on selection information (external information) set beforehand via, for example, the operated portion 17 shown in FIG. 1, one of the small images D2a and D3a is chosen as the small image D4a. The choice may be made according to an index value representing the combination of the above-mentioned edge intensity, exposure time, and selection information.

Next, in step S58, the small image D4a is subjected to brightness normalization with respect to the small image D1a. That is, the brightness value of each pixel of the small image D4a is multiplied by a fixed value such that the small images D1a and D4a have an equal brightness level (such that the average brightness of the small image D1a is equal to that of the small image D4a). The small image D4a having undergone the brightness normalization is taken as a small image D4b.

The small images D1a and D4b obtained as described above are taken as a degraded image and an initially restored image respectively (step S59). The flow then proceeds to step S10 to execute the processing in steps S10, S11, S12, and S13 sequentially.

The processing in steps S10 to S13 is similar to that in the first example of processing. The difference is that, since the filter coefficients of the image restoration filter obtained through steps S10 and S11 (and the PSF obtained through step S10) are adapted to the image size of a moving image, these are here re-adapted to the image size of a still image by vertical and horizontal enlargement. The vertical and horizontal enlargement here is similar to that described in connection with the second example of processing.

After the filter coefficients of the image restoration filter are found in step S11, then, in step S12, the correction target image D1 is filtered by use of this image restoration filter to generate a filtered image in which the blur contained in the correction target image D1 has been eliminated or reduced. The filtered image may contain ringing ascribable to the filtering, and thus then, in step S13, the ringing is eliminated to generate the definitive corrected image.

### Discussion on the Different Examples of Processing

Below will be discussed the significance of using the first to fourth examples of processing, along with modified examples of them.

Shot with an exposure time shorter than for ordinary-exposure shooting, the reference image, though having low brightness, contains less camera shake; thus, its edge component is close to that of an image free of camera shake. This is the reason that, as described above, an image obtained from the reference image is taken as an initially restored image (the initial value of a restored image) for Fourier iteration.

As the loop processing of Fourier iteration is repeated, the restored image (f′) becomes closer and closer to an image having camera shake reduced as much as possible. Here, since the initially restored image itself is close to an image free of camera shake, the convergence is achieved more quickly than when a random image or a degraded image is taken as an initially restored image (at the shortest, the convergence is achieved through one round of the loop processing). As a result, the processing time for creating camera shake information (a PSF, or the filter coefficients of an image restoration filter) and the processing time for camera shake correction are reduced. Moreover, whereas if the initially restored image is far removed from the image on which it should converge, with high probability it converges on a local solution (an image different from the one on which it should desirably converge), setting the initially restored image as described above reduces the probability of convergence on a local solution (i.e. reduces the probability of failure to correct camera shake).

Moreover, since camera shake is believed to degrade an entire image uniformly, a small region is extracted from each relevant image, and, from the image data of such small regions, camera shake information (a PSF, or the filter coefficients of an image restoration filter) is created, which is then applied to the entire image. This reduces the amount of calculation needed, and reduces the processing time for creating camera shake information and the processing time for camera shake correction. Needless to say, also expected is a reduction in the scale of the circuitry needed accompanied by a resulting reduction in cost.

Here, as described in connection with each example of processing, a characteristic small region containing a large edge component is automatically extracted. An increase in the edge component in a source image for calculation of a PSF means an increase in the proportion of the signal component to the noise component. Thus extracting a characteristic small region reduces the effect of noise, and makes more accurate detection of camera shake information possible.

The second example of processing requires no shooting dedicated to acquisition of a reference image; the first, third, and fourth examples of processing only once requires shooting dedicated to acquisition of a reference image (short-exposure shooting). Thus almost no increase in the load for shooting is involved. Moreover, needless to say, since camera shake detection and camera shake correction are achieved without the need for an angular velocity sensor or the like, the cost of the image sensing apparatus 1 is reduced.

In connection with the first, third, and fourth examples of processing (see FIGS. 3, 10, and 13), it has been described that the reference image A2, C2, or D2 is obtained by short-exposure shooting immediately after the ordinary-exposure shooting for acquiring the correction target image. Alternatively, the reference image may be obtained by short-exposure shooting immediately before the ordinary-exposure shooting. In that case, in the third and fourth examples of processing, the reference image C3 or D3 is the through-display image in the frame immediately after the frame in which the correction target image is shot.

In the above examples of processing, in the process of generating from small images the degraded image and the initially restored image for Fourier iteration, each small image is subjected to one or more of noise elimination, brightness normalization, edge extraction, and image size normalization (see FIGS. 3, 7, 10, and 13). The ways these different kinds of processing are applied as specifically described in connection with the examples of processing are merely examples, and may be modified in many ways. In an extreme case, in the process of generating the degraded image and the initially restored image in any example of processing, each small region may be subjected to all the four kinds of processing mentioned above (though image size normalization is meaningless in the first example of processing).

As the method for extracting a characteristic small region containing a relatively large edge component from the correction target image or the reference image, a variety of methods can be adopted. For example, such extraction may be achieved by use of an AF evaluation value calculated in automatic focus control. This automatic focus control employs a contrast detection method of the TTL (through-the-lens) type.

The image sensing apparatus 1 is provided with an AF evaluator (unillustrated). The AF evaluator divides each shot image (or through-display image) into a plurality of partial regions, and for each partial region calculates an AF evaluation value commensurate with the contrast ratio of the image inside it. Referring to the AF evaluation value for one of those partial regions, the main controller 13 in FIG. 1 controls the position of the focus lens in the image sensing portion 11 by hill-climbing control such that the AF evaluation value takes the greatest (or a maximal) value, so that an optical image of the subject is focused on the image-sensing surface of the image sensing device.

In a case where such autofocus control is executed, when a characteristic small region is extracted from the correction target image or the reference image, the AF evaluation values for the partial regions of the extraction source image are referred to. For example, of all the AF evaluation values for the partial regions of the extraction source image, the greatest one is identified, and the partial region (or a region determined relative to it) corresponding to the greatest AF evaluation value is extracted as the characteristic small region. Since the AF evaluation value increases as the contrast ratio (or the edge component) in the partial region increases, this can be exploited to extract a small region containing a relatively large edge component as a characteristic small region.

### Second Embodiment

Next, an image sensing apparatus according to a second embodiment of the invention will be described. The overall block diagram of the image sensing apparatus according to the second embodiment is the same as that shown in FIG. 1, and therefore the image sensing apparatus according to the second embodiment will also be referred to by the reference sign 1. The image sensing apparatus 1 according to the second embodiment is likewise provided with blocks referred to by the reference signs 11 to 19 (see FIG. 1), and the basic operation of these blocks is similar to that in the first embodiment. The second embodiment makes use of the technical features described in connection with the first embodiment, and the description of the first embodiment applies to the second embodiment as well.

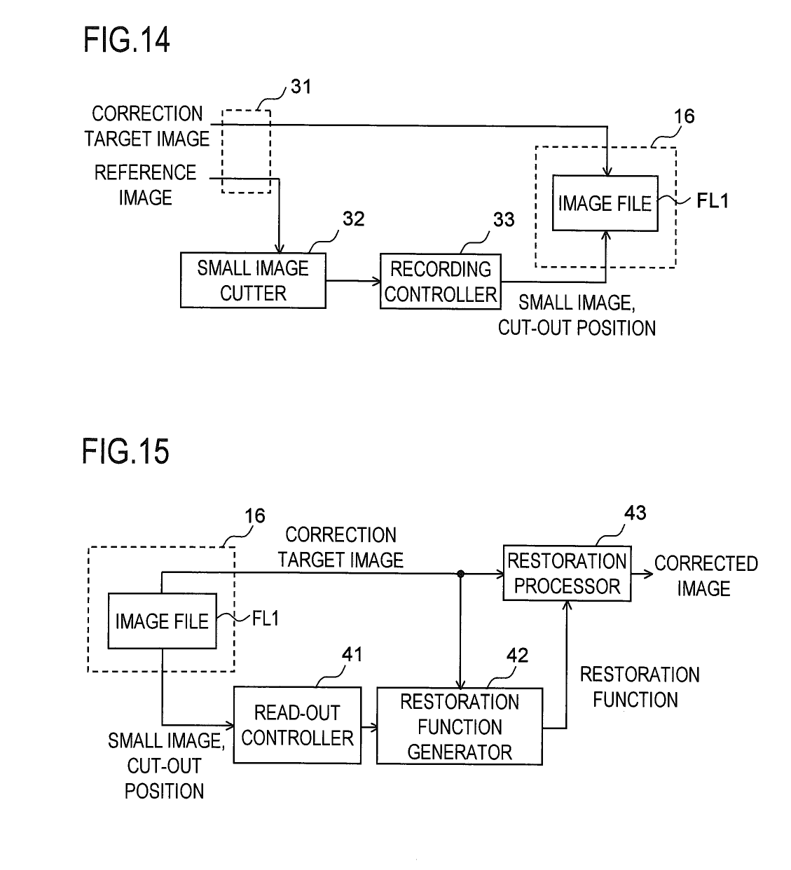

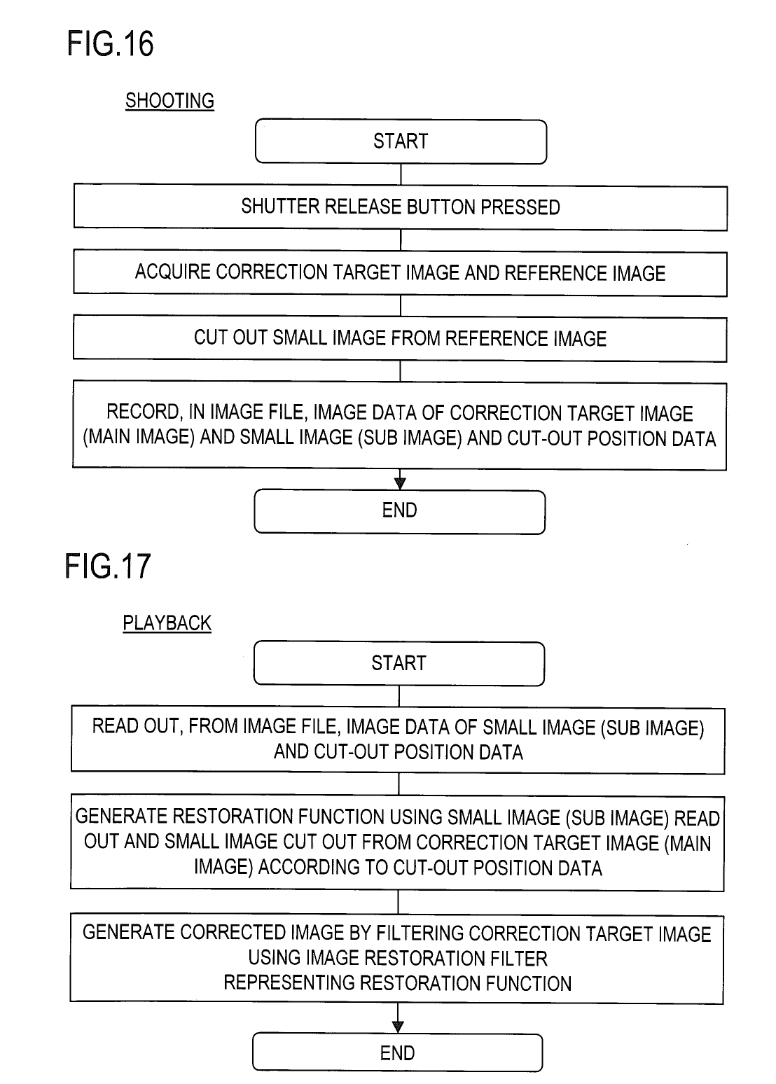

FIG. 14 is a block diagram showing the configuration of the blocks related to shooting provided in the image sensing apparatus 1, and FIG. 15 is a block diagram showing the configuration of the blocks related to playback provided in the image sensing apparatus 1. FIG. 16 is a flow chart showing the operation procedure of the blocks related to shooting, and FIG. 17 is a flow chart showing the operation procedure of the blocks related to playback.

For example, an image acquirer 31 in FIG. 14 is provided in the main controller 13 in FIG. 1, and a small image cutter 32 and a recording controller 33 in FIG. 14 are provided in the camera shake detector/corrector 19 in FIG. 1. Moreover, for example, a read-out controller 41, a restoration function generator 42, and a restoration processor 43 in FIG. 15 are provided in the camera shake detector/corrector 19. In FIGS. 14 and 15, the symbol FL1 represents an image file in which a correction target image is to be recorded. The image file FL1 is saved on the recording medium 16.

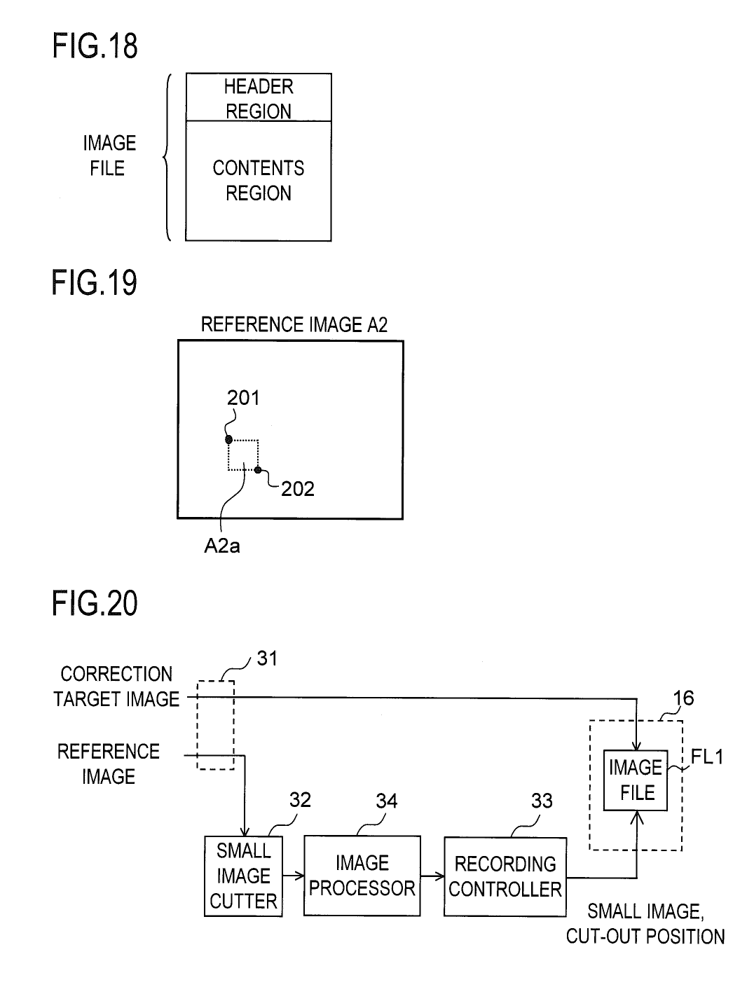

FIG. 18 shows the structure of an image file, like the image file FL1, to be saved on the recording medium 16. The image file is composed of a header region and a contents region, and the header region and the contents region defined within a single image file are associated with each other. Thus the data in the header region and that in the contents region stored in a single image file are associated with each other.

Now, with reference to FIGS. 14 and 16, an outline of the operation during shooting will be described. In shooting mode, when the shutter release button 17a is pressed, the image acquirer 31 acquires, as a correction target image, one shot image obtained by exposure after the press of the shutter release button 17a, and acquires, as a reference image, a shot image obtained before or after the shooting of the correction target image. As described in connection with the first embodiment, the exposure time with which the reference image is shot is shorter than that of the correction target image.

The small image cutter 32 cuts out, as a small image, part of the reference image. The recording controller 33 records in the header region of the image file FL1 the image data of the cut-out small image along with cut-out position data representing the position from which the small image was cut out. On the other hand, the image data of the correction target image is recorded in the contents region of the image file FL1.

The correction target image may be called the “main image” to be recorded in the image file FL1 at the press of the shutter release button 17a; the small image recorded in the header region of the image file FL1 may be called the “sub image” for correcting blur-induced degradation in the correction target image.

Now, with reference to FIGS. 15 and 17, an outline of the operation during playback will be described. In playback mode, when an operation is made on the operated portion 17 in FIG. 1 to request playback of the image recorded in the image file FL1, the contents of the operation are fed to the main controller 13 in FIG. 1, and the image data of the correction target image recorded in the image file FL1 is sent via the main controller 13 to the restoration processor 43 and the restoration function generator 42 in FIG. 15. On the other hand, meanwhile, the read-out controller 41 reads out the image data of the small image and the cut-out position data recorded in the header region of the image file FL1, and sends the data read out to the restoration function generator 42.

Thereafter the restoration function generator 42 generates a restoration function (in other words, deconvolution function) by use of the small image (sub image) read out and the small image cut out from the correction target image (main image) according to the cut-out position data. More specifically, based on the two small images, the Fourier iteration described in connection with the first embodiment is executed, thereby the condition of blur-induced degradation in the correction target image is estimated (i.e. a PSF is found), and a restoration function for correcting the degradation is generated. The restoration function is represented by an image restoration filter, and by filtering the correction target image by use of that image restoration filter, the restoration processor 43 generates a corrected image. In practice, the restoration function generator 42 calculates the filter coefficients of the image restoration filter and sends them to the restoration processor 43. The restoration processor 43 is provided with a block where it applies a two-dimensional spatial filter to an image, and, by substituting the received filter coefficients in the two-dimensional spatial filter, forms the image restoration filter.

As will be clear from the description of the first embodiment, each pixel value of the small images cut out from the correction target image and the reference image includes information representing the brightness of the pixel. Specifically, for example, those small images are each a brightness image (an image of varying density levels as quantized with respect to brightness).

Now, the operation of the blocks shown in FIGS. 14 and 15 will be described in conjunction with each of the first to fourth examples of processing described in connection with the first embodiment. Below will be described, as corresponding to the first to fourth examples of processing, a first to a fourth example of operation one by one. Unless inconsistent, any description given in connection with one example of operation applies to any other.

### First Example of Operation

First, a first example of operation will be described. The first example of operation deals with the operation of the blocks shown in FIGS. 14 and 15 in a case where the first example of processing of the first embodiment is adopted. Reference will also be made back to FIGS. 2 and 3, which correspond to the first example of processing.

In the first example of operation, the image acquirer 31 in FIG. 14 acquires a correction target image A1 and a reference image A2 (see FIG. 3). In the first example of operation, the small image cut out by the small image cutter 32 is the small image A2a in FIG. 3. For example, by performing the processing in steps S5 and S6 in FIG. 2, the small image cutter 32 cuts out (extracts) the small image A2a. In this case, first a small image Ala is extracted and then the small image A2a is extracted. Alternatively, it is also possible to extract the small image A2a without extracting a small image Ala; specifically, it is possible to extract a characteristic small region from the reference image A2 by use of the Harris corner detector or the like and then cut out, from the reference image A2, the image inside the extracted small region as the small image A2a.

In the first example of operation, the image data recorded in the header region of the image file FL1 is that of the small image A2a. The cut-out position data recorded in the header region of the image file FL1 determines, at the time of playback, the coordinate position of the small image Ala cut out from the correction target image A1. For example, the cut-out position data represents the coordinates, as measured on the reference image A2, of the pixels 201 and 202 located at the upper-left and lower-right corners of the small image A2a (see FIG. 19).

Based on the cut-out position data fed to it via the read-out controller 41, the restoration function generator 42 extracts a small region from the correction target image A1 to generate the small image A1a. Moreover, from the small image A2a recorded in the header region of the image file FL1 through the processing in steps S7 and S8, the restoration function generator 42 generates a small image A2c (see FIGS. 2 and 3); then, by executing the processing in steps S9 to S11 by use of the small images A1a and A2c, the restoration function generator 42 finds, through calculation of a PSF as a degradation function, a restoration function (i.e. the filter coefficients of an image restoration filter).

A correction target image is assumed to be an image obtained as a result of an ideal image—containing no blur—being acted upon by a degradation function. On the other hand, a restoration function is a function that performs a transform inverse to the transform resulting from a degradation function acting upon an image. Accordingly, making a restoration function act upon a correction target image eliminates blur from the correction target image.

By executing the processing in steps S12 and S13 by use of the restoration function found, the restoration processor 43 generates from the correction target image A1, through generation of a filtered image, a corrected image.

For example, in a case where the image restoration filter has a filter size of 5×5, the relationship between the pixel values of the pixels composing the filtered image and the pixel values of the pixels composing the correction target image is expressed by formula (7) below. Here, I_{F}(i, j) represents the pixel value of the pixel at the coordinate position (i, j) on the filtered image, I_{O}(i+u, j+v) represents the pixel value of the pixel at the coordinate position (i+u, j+v) on the correction target image, and w(u, v) represents the filter coefficient of the image restoration filter at the coordinate position (u, v).

$${I}_{F} ( i , j ) = {\sum }_{u , v} \{ w ( u , v ) \cdot {I}_{O} ( i + u , j + v ) \} \\ ( where - 2 \leq u \leq 2 and - 2 \leq v \leq 2 ) . \qquad ( 7 )$$

The corrected image is obtained through weighted averaging of the filtered image and the correction target image. The weighted averaging here eliminates ringing resulting from filtering. For example, the weighted averaging is performed pixel by pixel, and the proportion of the weighted averaging at each pixel is determined according to the edge intensity at that edge on the correction target image. This method of eliminating ringing through weighted averaging is well known, and therefore no detailed explanation of it will be given (see, for example, JP-A-2006-129236). Removal of ringing through weighted averaging may be omitted. In that case, the filtered image is taken as the corrected image to be found definitively (this applies also to the second to fourth examples of operation described later). Without doubt, the filtered image is on its own a blur-eliminated image.

In the example described above, at the time of shooting, the small image A2a in FIG. 3 is recorded in the image file FL1. Instead of the small image A2a, the small image A2b or A2c may be recorded. In that case, as shown in FIG. 20, between the small image cutter 32 and the recording controller 33, an image processor 34 is provided. Then, for example, by subjecting the small image A2a extracted by the small image cutter 32 to necessary processing—such as the noise elimination in step S7—as described in connection with the first example of processing, the image processor 34 generates the small image A2b or A2c. The recording controller 33 then records in the header region of the image file FL1 the small image A2b or A2c generated by the image processor 34. In this case, the restoration function generator 42 in FIG. 15 does not need to perform part or all of the processing in steps S7 and S8.

### Second Example of Operation

Next, a second example of operation will be described. The second example of operation deals with the operation of the blocks shown in FIGS. 14 and 15 in a case where the second example of processing of the first embodiment is adopted. Reference will also be made back to FIGS. 6 and 7, which correspond to the second example of processing.

In the second example of operation, the image acquirer 31 in FIG. 14 acquires a correction target image B1 and a reference image B3 (see FIG. 7). In the second example of operation, the small image cut out by the small image cutter 32 is the small image B3a in FIG. 7. By performing the processing in step S25 in FIG. 6, the small image cutter 32 extracts the small image B3a.

In the second example of operation, the image data recorded in the header region of the image file FL1 is that of the small image B3a. The cut-out position data recorded in the header region of the image file FL1 determines, at the time of playback, the coordinate position of the small image B1a cut out from the correction target image B1. For example, the cut-out position data represents the coordinates, as measured on the reference image B3, of the pixels located at the upper-left and lower-right corners of the small image B3a.

By executing the processing in step S26 based on the cut-out position data fed to it via the read-out controller 41, the restoration function generator 42 generates the small image B1a from the correction target image B1. Moreover, through the processing in steps S27 and S28, the restoration function generator 42 generates a small image B1c from the small image B1a, and generates a small image B3c from the small image B3a recorded in the header region of the image file FL1 (see FIGS. 6 and 7). Subsequently, by executing the processing in steps S29, S10, and S11 by use of the small images B1c and B3c, the restoration function generator 42 finds, through calculation of a PSF as a degradation function, a restoration function (i.e. the filter coefficients of an image restoration filter).

Thereafter, by executing the processing in steps S12 and S13, the restoration processor 43 generates from the correction target image B1, through generation of a filtered image, a corrected image.

In the example described above, at the time of shooting, the small image B3a in FIG. 7 is recorded in the image file FL1. Instead of the small image B3a, the small image B3b or B3c may be recorded. In that case, as shown in FIG. 20, between the small image cutter 32 and the recording controller 33, an image processor 34 is provided. Then, for example, by subjecting the small image B3a extracted by the small image cutter 32 to necessary processing—such as the edge extraction in step S27—as described in connection with the second example of processing, the image processor 34 generates the small image B3b or B3c. The recording controller 33 then records in the header region of the image file FL1 the small image B3b or B3c generated by the image processor 34. In this case, the restoration function generator 42 in FIG. 15 does not need to perform part or all of the processing in steps S27 and S28.

### Third Example of Operation

Next, a third example of operation will be described. The third example of operation deals with the operation of the blocks shown in FIGS. 14 and 15 in a case where the third example of processing of the first embodiment is adopted. Reference will also be made back to FIGS. 9 and 10, which correspond to the third example of processing.

In the third example of operation, the image acquirer 31 in FIG. 14 acquires a correction target image C1 and reference images C2 and C3 (see FIG. 10). In the third example of operation, the small images cut out by the small image cutter 32 are the small images C2a and C3a in FIG. 10. By performing the processing in steps S35 and S36 in FIG. 6, the small image cutter 32 extracts the small images C2a and C3a.

In the third example of operation, the image data recorded in the header region of the image file FL1 is, for example, that of the small image C4a or C4b in FIG. 10. In this case, as shown in FIG. 20, between the small image cutter 32 and the recording controller 33, an image processor 34 is provided, which performs the processing in steps S37 and S38, or in steps S37 to S39, in FIG. 9. The cut-out position data recorded in the header region of the image file FL1 determines, at the time of playback, the coordinate position of the small image C1a cut out from the correction target image C1. For example, the cut-out position data represents the coordinates, as measured on the reference image C3, of the pixels located at the upper-left and lower-right corners of the small image C3a.

Based on the cut-out position data fed to it via the read-out controller 41, the restoration function generator 42 extracts a small region from the correction target image C1 to generate the small image C1a. Moreover, based on the image data of the small image recorded in the header region of the image file FL1, the restoration function generator 42 obtains the small image C4b. Here, as necessary, the processing in step S39 is executed. Subsequently, by executing the processing in steps S40, S10, and S11 by use of the small images C1a and C4b, the restoration function generator 42 finds, through calculation of a PSF as a degradation function, a restoration function (i.e. the filter coefficients of an image restoration filter).

Thereafter, by executing the processing in steps S12 and S13, the restoration processor 43 generates from the correction target image C1, through generation of a filtered image, a corrected image.

In the example described above, at the time of shooting, the small image C4a or C4b in FIG. 10 is recorded in the image file FL1. Instead, the two small images C2a and C3a may be recorded in the header region of the image file FL1. In that case, the image processor 34 in FIG. 20 is omitted, and instead the restoration function generator 42 in FIG. 15 is furnished with the function of generating the small image C4b from the small images C2a and C3a.

### Fourth Example of Operation

Next, a fourth example of operation will be described. The fourth example of operation deals with the operation of the blocks shown in FIGS. 14 and 15 in a case where the fourth example of processing of the first embodiment is adopted. Reference will also be made back to FIGS. 12 and 13, which correspond to the fourth example of processing.

In the fourth example of operation, the image acquirer 31 in FIG. 14 acquires a correction target image D1 and reference images D2 and D3 (see FIG. 13). In the fourth example of operation, the small images cut out by the small image cutter 32 are the small images D2a and D3a in FIG. 13. By performing the processing in steps S55 and S56 in FIG. 6, the small image cutter 32 extracts the small images D2a and D3a.

In the fourth example of operation, the image data recorded in the header region of the image file FL1 is, for example, that of the small image D4a or D4b in FIG. 13. In this case, as shown in FIG. 20, between the small image cutter 32 and the recording controller 33, an image processor 34 is provided, which performs the processing in step S57, or in steps S57 and S58, in FIG. 12. The cut-out position data recorded in the header region of the image file FL1 determines, at the time of playback, the coordinate position of the small image D1a cut out from the correction target image D1. For example, the cut-out position data represents the coordinates, as measured on the reference image D3, of the pixels located at the upper-left and lower-right corners of the small image D3a.

Based on the cut-out position data fed to it via the read-out controller 41, the restoration function generator 42 extracts a small region from the correction target image D1 to generate the small image D1a. Moreover, based on the image data of the small image recorded in the header region of the image file FL1, the restoration function generator 42 obtains the small image D4b. Here, as necessary, the processing in step S58 is executed. Subsequently, by executing the processing in steps S59, S10, and S11 by use of the small images D1a and D4b, the restoration function generator 42 finds, through calculation of a PSF as a degradation function, a restoration function (i.e. the filter coefficients of an image restoration filter).

Thereafter, by executing the processing in steps S12 and S13, the restoration processor 43 generates from the correction target image D1, through generation of a filtered image, a corrected image.

In the example described above, at the time of shooting, the small image D4a or D4b in FIG. 13 is recorded in the image file FL1. Instead, the two small images D2a and D3a may be recorded in the header region of the image file FL1. In that case, the image processor 34 in FIG. 20 is omitted, and instead the restoration function generator 42 in FIG. 15 is furnished with the function of generating the small image D4b from the small images D2a and D3a.

Recording in an image file a small image cut out from a reference image along with a correction target image as in this embodiment makes it possible, at the time of playback, to correct blur in the correction target image. Since the small image contains less image data, recording it along with the correction target image, as compared with simply recording two full shot images as conventionally practiced, requires less recording capacity.

### Third Embodiment

In the second embodiment, one small image is cut out from one reference image, one restoration function is generated for one correction target image, and the one restoration function is made to act upon the entire correction target image to correct degradation in the correction target image. Alternatively, a plurality of small images may be cut out from one reference image. As an embodiment in which a plurality of small images are cut out from one reference image, a third embodiment of the invention will be described below. The third embodiment is a modified embodiment of the second embodiment. Accordingly, the following description focuses on the differences from the second embodiment. The third embodiment makes use of the technical features described in connection with the first and second embodiments, and unless inconsistent, the description of the first and second embodiments applies to the third embodiment as well.

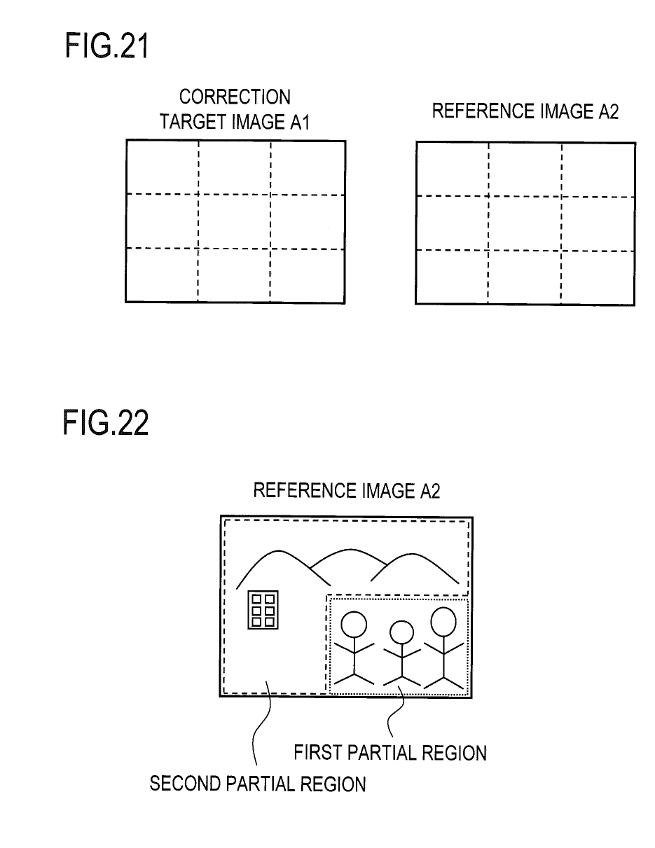

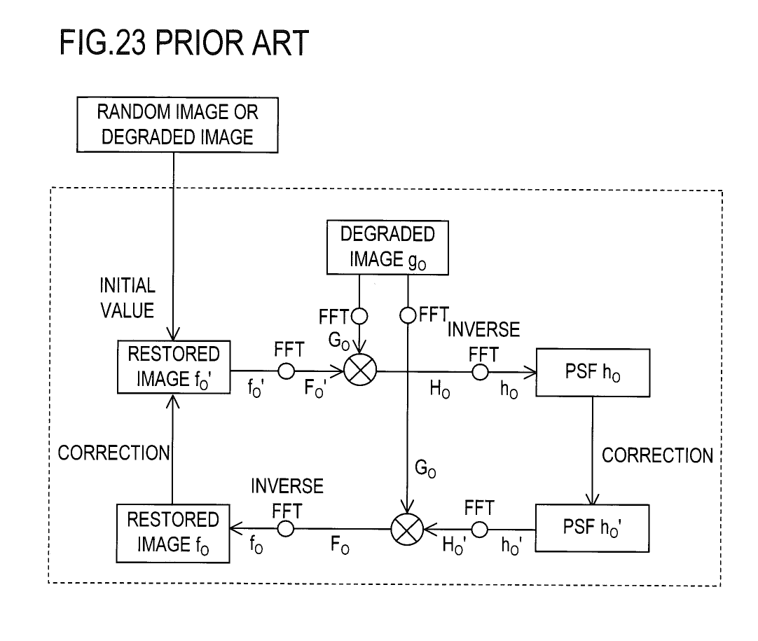

For the sake of concreteness of description, assume that the image acquirer 31 in FIG. 14 has acquired the correction target image A1 and the reference image A2 in FIG. 3. The small image cutter 32 in FIG. 14 divides the entire region of the reference image A2 into n parts (where n is an integer of 2 or more). Suppose here that n=9, and specifically that the entire region of the reference image A2 is divided into three vertically and three horizontally so that it is divided into nine partial regions as shown in FIG. 21. In FIG. 21, the broken lines represent the boundaries of the division. Then, by use of the Harris corner detector or the like, a characteristic small region is extracted from each partial region, and the image inside each such small region is, as a small image, cut out from the reference image A2. The recording controller 33 records the image data of a total of nine small images thus cut out, along with cut-out position data representing the position from which they were cut out, in the header region of the image file FL1. On the other hand, the image data of the correction target image A1 is recorded in the contents region of the image file FL1.

In playback mode, when an operation is made on the operated portion 17 in FIG. 1 to request the playback of the image recorded in the image file FL1, the contents of the operation are fed to the main controller 13 in FIG. 1, and the image data of the correction target image recorded in the image file FL1 is sent via the main controller 13 to the restoration processor 43 and the restoration function generator 42 in FIG. 15. On the other hand, meanwhile, the read-out controller 41 reads out the image data of the small images and the cut-out position data recorded in the header region of the image file FL1, and sends the data read out to the restoration function generator 42.

Just as the entire region of the reference image A2 is divided into nine partial regions, the entire region of the correction target image A1 is, by the restoration function generator 42, divided into nine partial regions (see FIG. 21). Then, according to the cut-out position data, the restoration function generator 42 cuts out, for each partial region, a small image from the correction target image, and executes, for each partial region, Fourier iteration by use of the small image on the correction target image A1 and the small image on the reference image A2 to find, for each partial region, a restoration function. Each restoration function is represented by an image restoration filter. By executing on the image inside each partial region on the correction target image A1 filtering using the corresponding image restoration filter, the restoration processor 43 generates a filtered image, and then generates, through elimination of ringing, a corrected image.

In a case where the image sensing apparatus 1 is affected by camera shake acting in the up/down and/or left/right direction alone, the camera shake is believed to degrade an entire image uniformly. If camera shake contains a rotational component, however, the degradation function (PSF) differs from one position to another on the correction target image; as a result, the restoration function to be made to act differs from one position to another on the correction target image. In such a case, it is useful to cut out and record a plurality of small images.

For another example, in a case where a subject at a close distance—such as a person—and a subject at a far distance—such as a mountain—coexist within the shooting region, the restoration function optimal for the region where the person appears differs from that optimal for the region where the mountain appears (because the degradation function differs between the regions). Also in such a case of coexistence, it is useful to cut out and record a plurality of small images. For example, by use of a distance-measuring sensor (unillustrated), or by a distance measurement method of the TTL (through-the-lens) type, the distance to each subject appearing within the shooting region is calculated and, as shown in FIG. 22, the entire region of the reference image A2 is divided into a first partial region, where a subject at a relatively close distance appears, and a second partial region, where a subject at a relatively far distance appears (in this case, n=2). The operation thereafter is the same as described above except that the value of n is different. Here, the distance to a subject denotes the distance from the image sensing apparatus 1 to the subject in the real space.

Although the foregoing deals with, as an example, the operation in a case where the correction target image A1 and the reference image A2, corresponding to the first example of processing and the first example of operation, are acquired, the method according to this embodiment may be applied to the second example of processing and the second example of operation, to the third example of processing and the third example of operation, and to the fourth example of processing and the fourth example of operation.

### Fourth Embodiment

Next, an image sensing apparatus according to a fourth embodiment of the invention will be described. The overall block diagram of the image sensing apparatus according to the fourth embodiment is the same as that shown in FIG. 1, and therefore the image sensing apparatus according to the fourth embodiment will also be referred to by the reference sign 1. The image sensing apparatus 1 according to the fourth embodiment is likewise provided with blocks referred to by the reference signs 11 to 19 (see FIG. 1), and the basic operation of these blocks is similar to that in the first embodiment. The fourth embodiment makes use of the technical features described in connection with the first embodiment, and the description of the first embodiment applies to the fourth embodiment as well.

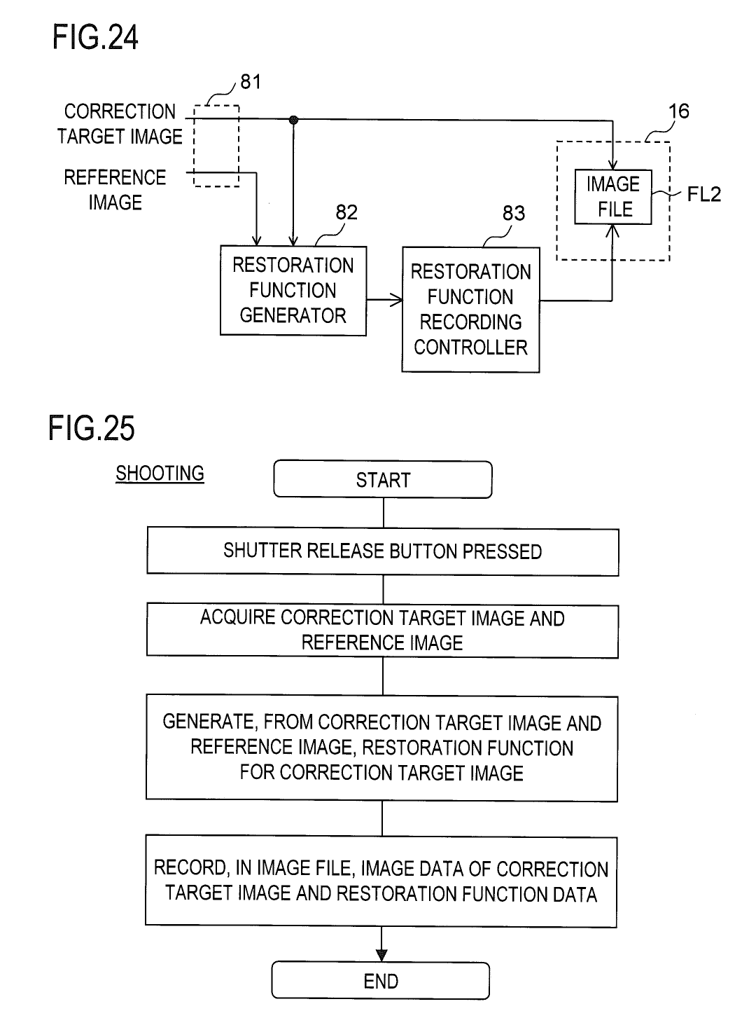

The configuration and operation of the blocks related to shooting provided in the image sensing apparatus 1 will now be described. FIG. 24 is a block diagram showing the configuration of the blocks related to shooting, and FIG. 25 is a flow chart showing the operation procedure of those blocks.

For example, an image acquirer 81 in FIG. 24 is provided in the main controller 13, and a restoration function generator 82 and a restoration function recording controller 83 are provided in the camera shake detector/corrector 19 in FIG. 1. The symbol FL2 represents an image file in which a correction target image is to be recorded. The image file FL2 is saved on the recording medium 16. The structure of the image file FL2 is similar to that of the image file FL1 shown in FIG. 18.

Now, the operation of the blocks shown in FIG. 24 will be described (with reference also to FIG. 25). In shooting mode, when the shutter release button 17a is pressed, the image acquirer 81 acquires, as a correction target image, one shot image obtained by exposure after the press of the shutter release button 17a, and acquires, as a reference image, a shot image obtained before or after the shooting of the correction target image. It is assumed that the exposure time with which the reference image is shot is shorter than that of the correction target image.

Thereafter, based on the image data of the correction target image and the reference image, the restoration function generator 82 generates a restoration function for eliminating the blur contained in the correction target image. The restoration function recording controller 83 writes restoration function data representing the generated restoration function in the header region of the image file FL2. On the other hand, the image data of the correction target image is recorded in the contents region of the image file FL2.

Since the exposure time of the reference image is shorter than that of the correction target image, the reference image contains less blur than the correction target image. Thus, by comparing the correction target image with the restoration function, it is possible to estimate the condition of the blur contained in the correction target image, and to generate a restoration function according to the estimated result. An example of the method for generating the restoration function will be given later in the description of another embodiment.

Although FIG. 25 shows the procedure in which first the restoration function is generated and then the correction target image and the restoration function data are recorded in the image file FL2, it is also possible to concurrently generate the restoration function and record the correction target image in the image file FL2. For example, it is possible, before or in the middle of the generation of the restoration function, to start executing the processing for recording the correction target image in the image file FL2 and, after the recording of the correction target image, to record the restoration function data in the image file FL2. This helps reduce the time for generating the image file FL2 in which the correction target image and the restoration function data are recorded.

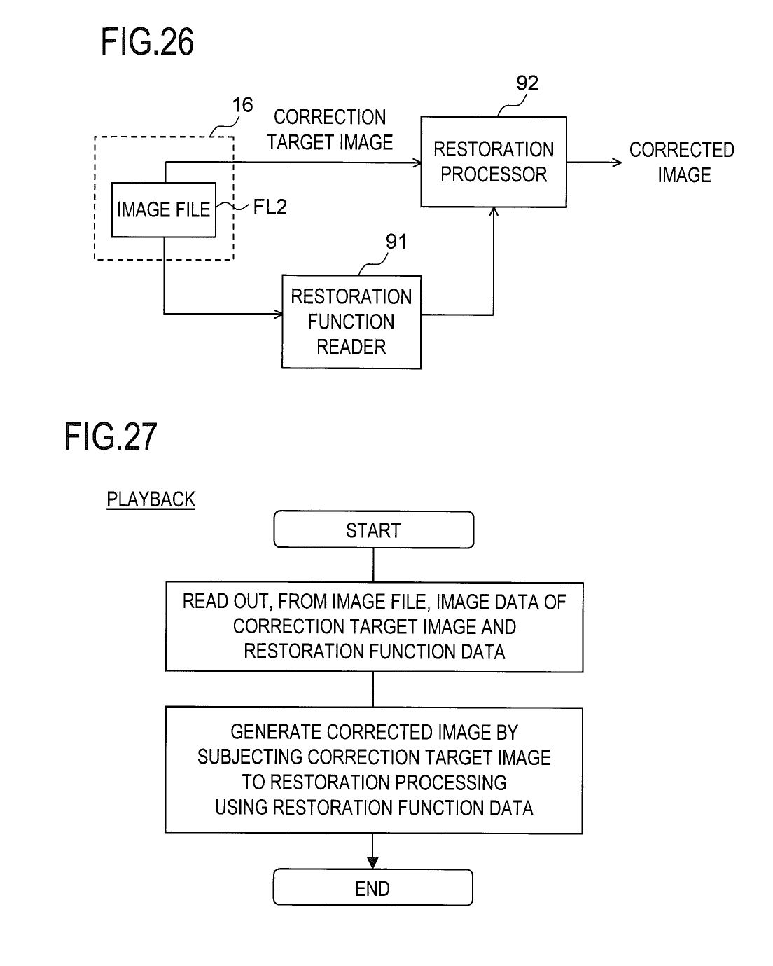

Next, the configuration and operation of the blocks related to playback provided in the image sensing apparatus 1 will be described. FIG. 26 is a block diagram showing the configuration of the blocks related to playback, and FIG. 27 is a flow chart showing the operation procedure of those blocks.

For example, a restoration function reader 91 and a restoration processor 92 in FIG. 26 are provided in the camera shake detector/corrector 19 in FIG. 1, and perform necessary operations under the control of the main controller 13. The image file FL2 in FIG. 26 is the same as that in FIG. 24.

In playback mode, when an operation is made on the operated portion 17 in FIG. 1 to request the playback of the image recorded in the image file FL2, the contents of the operation are fed to the main controller 13 in FIG. 1, and the image data of the correction target image recorded in the image file FL2 is sent via the main controller 13 to the restoration processor 92 in FIG. 26. On the other hand, meanwhile, the restoration function reader 91 reads out the restoration function data recorded in the header region of the image file FL2, and sends the restoration function data to the restoration processor 92.

By performing restoration processing using the restoration function data on the correction target image fed to it, the restoration processor 92 eliminates the blur contained in the correction target image to produce a corrected image having the blur eliminated. The generated corrected image is displayed on the display portion 15. Moreover, the generated corrected image can be recorded on the recording medium 16 in response to an operation on the operated portion 17.

Next, the restoration function will be described in detail. Although no degradation function is generated in the fourth embodiment, for the sake of convenience of description, the description of the restoration function will proceed along with that of the degradation function. The degradation function represents the condition of degradation in the correction target image due to blur.

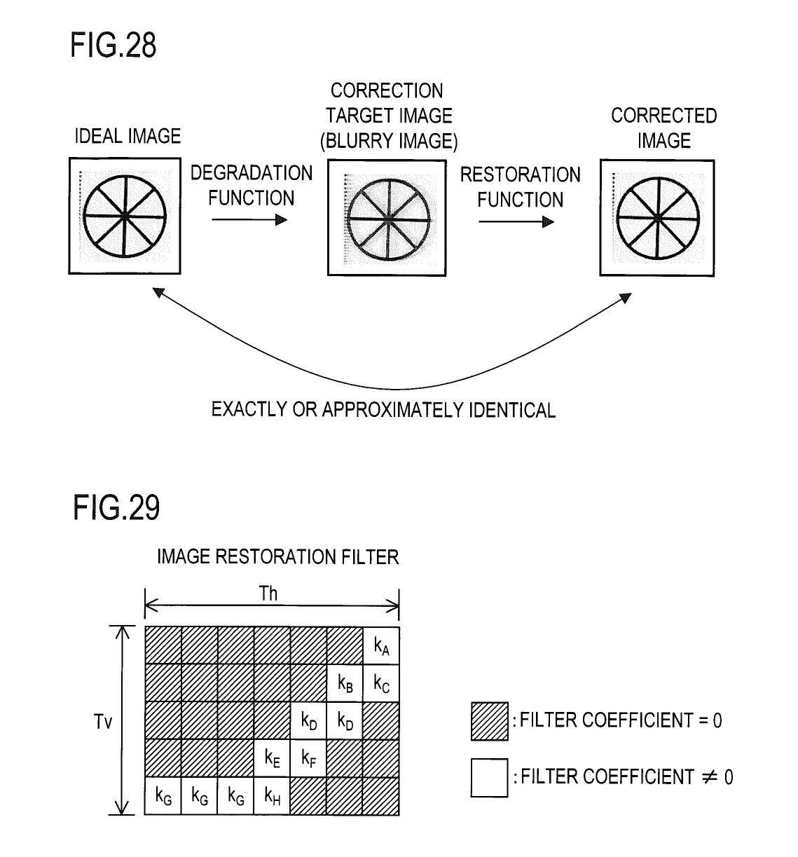

If camera shake occurs in the image sensing apparatus 1 during the exposure time of a correction target image, the correction target image contains blur. An image that would be obtained if no camera shake occurred in the image sensing apparatus 1 is called the “ideal image”. The correction target image, which may be called a blurry image, can thus be assumed to be, as shown in FIG. 28, an image obtained as a result of the ideal image being acted upon by a degradation function.

A restoration function is a function that performs a transform inverse to the transform resulting from a degradation function acting upon an image. Accordingly, making a restoration function act upon a correction target image eliminates blur from the correction target image. The corrected image obtained through this blur elimination is approximate to the ideal image, and, if the restoration function is one found ideally, the corrected image is exactly identical with the ideal image.

In practice, the restoration function is represented by a two-dimensional FIR (finite impulse response) filter. The two-dimensional FIR filter forming the restoration function will henceforth be called the “image restoration filter”. “Filter coefficients” is synonymous with “filter coefficient values”.

FIG. 29 shows an example of the image restoration filter. The symbols Th and Tv represent the horizontal filter size (otherwise put, the horizontal tap size) and the vertical filter size (otherwise put, the vertical tap size) of the image restoration filter. In the example shown in FIG. 29, Th and Tv are 7 and 5 (in pixels) respectively. Accordingly, the characteristic of this image restoration filter is defined by 35 filter coefficients, and enumerating the 35 filter coefficients in order of raster scanning from the upper-left to the lower-right corner of the image restoration filter gives the data sequence “000000k_{A}00000k_{B}k_{C}0000k_{D}k_{D}0000k_{E}k_{F}00k_{G}k_{G}k_{G}k_{H}000”. Here, k_{A} to k_{H} are filter coefficients that are non-zero.

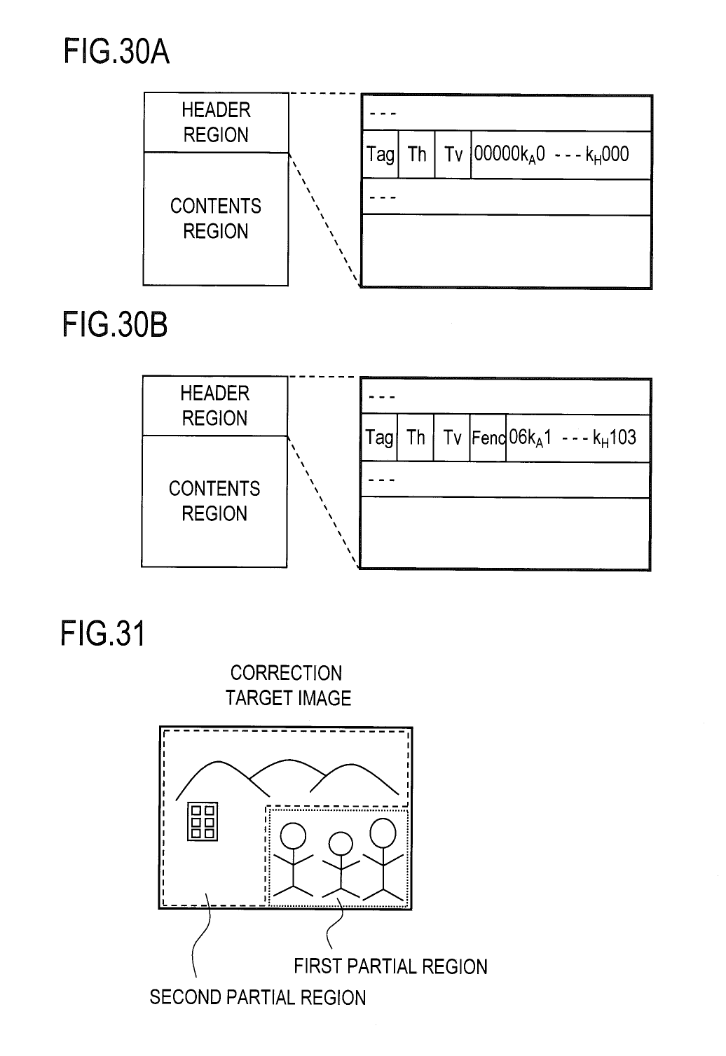

The restoration function recording controller 83 in FIG. 24 records, as the restoration function data, the filter size and the filter coefficients of the image restoration filter in the image file FL2. More specifically, the values of Th and Tv representing the filter size of the image restoration filter and the data sequence of the filter coefficients are, as the restoration function data, recorded in the header region of the image file FL2. In illustration of how the recording is done, FIG. 30A shows the data structure of the header region of the image file FL2. Here, “Tag” is the symbol that identifies the region where the restoration function data is recorded.

When the above data sequence is recorded, none of the filter coefficients is compressed; alternatively, they may be first compressed and then recorded. This helps reduce the recording region for the restoration function data. For example, the restoration function recording controller 83 in FIG. 24 is provided with a data sequence compressor (unillustrated), which compresses the above data sequence by a predetermined compression method such as run length encoding to produce the compressed data sequence “06k_{A}105k_{B}1k_{C}104k_{D}204k_{E}1k_{F}102k_{G}3k_{H}103”. In this case, the restoration function recording controller 83 records, as the restoration function data, the values of Th and Tv representing the filter size of the image restoration filter, the above compressed data sequence, and flag data Fenc representing the compression method used to obtain the compressed data sequence in the header region of the image file FL2. In illustration of how the recording is done, FIG. 30B shows the data structure of the header region of the image file FL2.

The restoration function reader 91 in FIG. 26 reads out, as the restoration function data, the values of Th and Tv and the data sequence of the filter coefficients from the image file FL2, and sends them to the restoration processor 92. In a case where the data sequence of the filter coefficients is compressed, first the values of Th and Tv, the compressed data sequence of the filter coefficients, and the flag data Fenc are red out from the image file FL2, then the compressed data sequence is decompressed according to the flag data Fenc, and the uncompressed data sequence obtained by the decompression is, along with the values of Th and Tv, sent to the restoration processor 92.

From the values of Th and Tv and the data sequence of the filter coefficients, the restoration processor 92 forms an image restoration filter representing a restoration function, and filters the correction target image by applying the image restoration filter to each of the pixels composing the correction target image. The image obtained by the filtering (more precisely, two-dimensional spatial filtering) is called the filtered image. Although the filter size of the image restoration filter is smaller than the image size of the correction target image, since camera shake is believed to degrade an entire image uniformly, by applying the image restoration filter to the entire correction target image, it is possible to eliminate the blur of the entire correction target image.

For example, in a case where Th=Tv=5, the relationship between the pixel values of the pixels composing the filtered image and the pixel values of the pixels composing the correction target image is expressed by formula (8) below. Here, I_{F}(i, j) represents the pixel value of the pixel at the coordinate position (i, j) on the filtered image, I_{O}(i+u, j+v) represents the pixel value of the pixel at the coordinate position (i+u, j+v) on the correction target image, and w(u, v) represents the filter coefficient of the image restoration filter at the coordinate position (u, v).

$${I}_{F} ( i , j ) = {\sum }_{u , v} \{ w ( u , v ) \cdot {I}_{O} ( i + u , j + v ) \} \\ ( where - 2 \leq u \leq 2 and - 2 \leq v \leq 2 ) . \qquad ( 8 )$$

Thereafter, by subjecting the filtered image and the correction target image to weighted averaging, the restoration processor 92 generates the definitive corrected image. The weighted averaging here eliminates ringing resulting from filtering. For example, the weighted averaging is performed pixel by pixel, and the proportion of the weighted averaging at each pixel is determined according to the edge intensity at that edge on the correction target image. This method of eliminating ringing through weighted averaging is well known, and therefore no detailed explanation of it will be given (see, for example, JP-A-2006-129236). Removal of ringing through weighted averaging may be omitted. In that case, the filtered image is taken as the corrected image to be found definitively. Without doubt, the filtered image is on its own a blur-eliminated image.

Although the foregoing deals with, as an example, a method in which the data sequence of the filter coefficients is compressed by run length encoding, it may instead be compressed by any method other than run length encoding. In a case where the data sequence of the filter coefficients is compressed by run length encoding, the amount of data may rather increase as compared with out compression. It is therefore also possible to make a plurality of compression methods available for the compression of the data sequence and select for actual compression the one that will offer the highest compression efficiency. In that case, if all those compression methods cause the amount of data to increase as compared with out compression, the data sequence of the filter coefficients are recorded in the image file FL2 without compression. For further reduction of the amount of data, the filter size of the image restoration filter representing the restoration function generated by the restoration function generator 82 in FIG. 24 may be reduced at an appropriate reduction factor by thinning-out or the like so that the reduced image restoration filter may be, along with the reduction factor, recorded in the image file FL2 (though compression involving such reduction is irreversible). In that case, at the time of playback, the reduced image restoration filter recorded in the image file FL2 is enlarged at the reciprocal of the reduction factor, and the restoration processing is performed by use of the image restoration filter thus enlarged back.

The restoration function reader 91 and the restoration processor 92 in FIG. 26 may be provided in an apparatus (e.g. a personal computer) other than the image sensing apparatus 1. Any apparatus that can apply filtering using a two-dimensional filter to an image can easily realize the functions of the restoration function reader 91 and the restoration processor 92.

According to one possible method of performing the restoration processing, at the time of shooting, detection data from a sensor for detecting camera shake of an image sensing apparatus, or a degradation function, is recorded on a recording medium, and, at the time of playback, restoration processing is performed based on a restoration function generated from the detection data or the degradation function. In a case where this method is adopted, a special calculating means for generating the restoration function needs to be provided at the side of a playback apparatus. Moreover, there may be more than one occasion that an image is played back and, in a case where the just-mentioned method is adopted, every time the image is played back, it is necessary to derive the restoration function from the sensor detection data or the degradation function. Since the calculation for the derivation requires considerable time (e.g. one to several seconds), playback takes time accordingly.

By contrast, by generating a restoration function at the time of shooting and recording it along with a correction target image in an image file as in this embodiment, it is possible, in any apparatus that can apply filtering using a two-dimensional filter to an image, to play back a blur-eliminated image. In this way, it is possible to form an apparatus that despite having a simple configuration is capable of image restoration, proving to be of great use. Moreover, without the need to perform calculation for deriving a restoration function every time playback occurs, it is possible to obtain a corrected image simply by performing filtering at the time of playback, making quicker playback of a corrected image possible.

In the example described above, one restoration function is generated for one correction target image, and the one restoration function is made to act upon the entire correction target image to correct degradation in the correction target image. Alternatively, it is possible to divide the entire region of one correction target image into n partial regions (where n is an integer of 2 or more) and find a restoration function for each partial region. In that case, the restoration function recording controller 83 in FIG. 24 records in the header region of the image file FL2 the restoration function data for the n restoration functions and the coordinate position of each partial region on the correction target image. Receiving the restoration function data and the coordinate positions of the partial regions from the header region of the image file FL2 via the restoration function reader 91, the restoration processor 92 in FIG. 26 forms an image restoration filter for each partial region. Then the restoration processor 92 executes filtering on the image inside each partial region on the correction target image by use of the corresponding image restoration filter, and thereby generates a filtered image.

In a case where the image sensing apparatus 1 is affected by camera shake acting in the up/down and/or left/right direction alone, the camera shake is believed to degrade an entire image uniformly. If camera shake contains a rotational component, however, the degradation function differs from one position to another on the correction target image; as a result, the restoration function to be made to act differs from one position to another on the correction target image. In such a case, it is useful to use a plurality of restoration functions.

For another example, in a case where a subject at a close distance—such as a person—and a subject at a far distance—such as a mountain—coexist within the shooting region, the restoration function optimal for the region where the person appears differs from that optimal for the region where the mountain appears (because the degradation function differs between the regions). Also in such a case of coexistence, it is useful to use a plurality of restoration functions. For example, by use of a distance-measuring sensor (unillustrated), or by a distance measurement method of the TTL (through-the-lens) type, the distance to each subject appearing within the shooting region is calculated and, as shown in FIG. 31, the entire region of the correction target image is divided into a first partial region, where a subject at a relatively close distance appears, and a second partial region, where a subject at a relatively far distance appears; then a restoration function is found for each partial region. Here, the distance to a subject denotes the distance from the image sensing apparatus 1 to the subject in the real space.

### Fifth Embodiment

Next, an image sensing apparatus according to a fifth embodiment of the invention will be described. The overall block diagram of the image sensing apparatus according to the fifth embodiment is the same as that shown in FIG. 1, and therefore the image sensing apparatus according to the fifth embodiment will also be referred to by the reference sign 1. The image sensing apparatus 1 according to the fifth embodiment is likewise provided with blocks referred to by the reference signs 11 to 19 (see FIG. 1), and the basic operation of these blocks is similar to that in the first embodiment. The fifth embodiment is a modified example of the fourth embodiment, and, unless inconsistent, any description of the fourth embodiment applies to the fifth embodiment as well. The following description of the fifth embodiment focuses on the differences from the fourth embodiment.

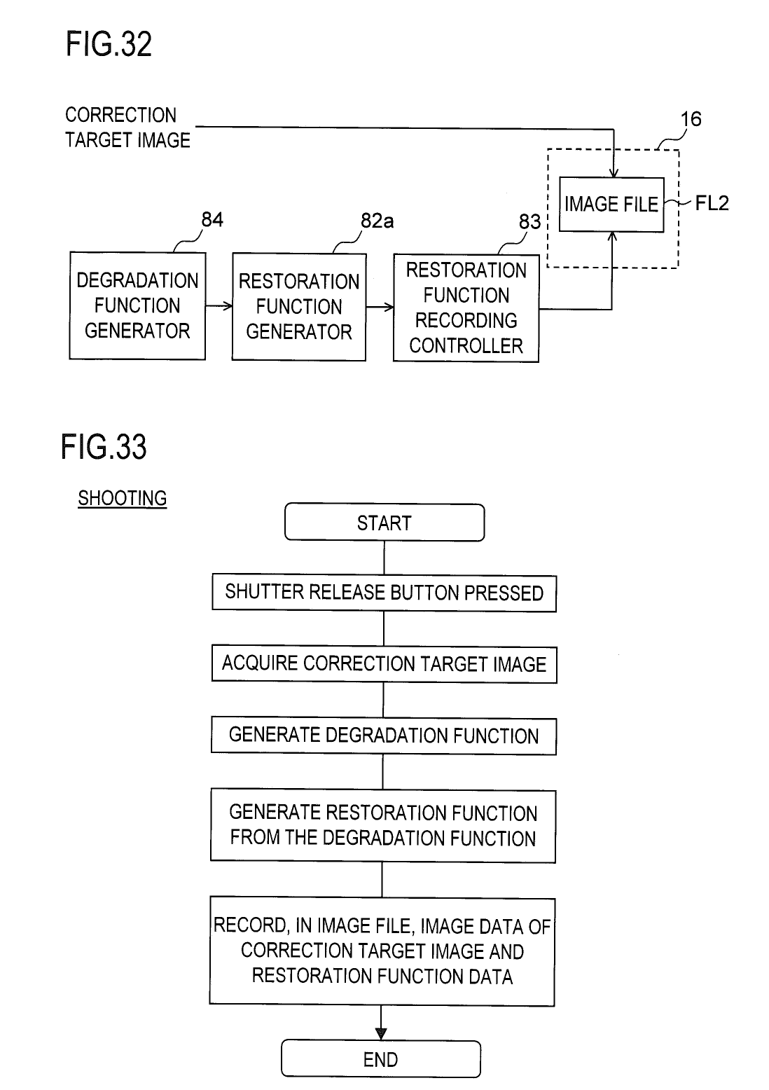

FIG. 32 is a block diagram of the blocks related to shooting provided in the image sensing apparatus 1 of the fifth embodiment. FIG. 33 is a flow chart showing the operation procedure of those blocks.

For example, a degradation function generator 84, a restoration function generator 82a, and a restoration function recording controller 83 in FIG. 32 are provided in the camera shake detector/corrector 19 in FIG. 1.

In shooting mode, when the shutter release button 17a is pressed, one shot image obtained by exposure after the press of the shutter release button 17a is acquired as a correction target image. On the other hand, the degradation function generator 84 generates a degradation function representing the condition of degradation in the correction target image due to blur.

As the method for generating the degradation function, any well known generation method may be adopted. For example, in a case where the image sensing apparatus 1 is provided with a camera shake detection sensor (unillustrated) for detecting movement of the body (unillustrated) of the image sensing apparatus 1, the degradation function is generated based on the detection result of the camera shake detection sensor during the exposure period of the correction target image. A method of generating a degradation function based on a detection result of a camera shake detection sensor is disclosed in, for example, JP-A-2006-129236, and the method disclosed there may be adopted in this embodiment.

The camera shake detection sensor is, for example, an angular velocity sensor that detects the angular velocity of the body of the image sensing apparatus 1, or an acceleration sensor that detects the acceleration of the body. The degradation function generator 84 acquires the detection result of the camera shake detection sensor during the exposure period of the correction target image; then, based on the detection result and the focal length of the image sensing portion 11, the degradation function generator 84 finds the locus described by a point on the ideal image as a result of camera shake in the body of the image sensing apparatus 1, and finds the filter coefficients (weighting coefficients) of a two-dimensional spatial filter weighted according to the locus. This two-dimensional spatial filter represents the degradation function. A degradation function like this is generally called a PSF (point spread function).

The degradation function may be generated by use of the method described in JP-A-2001-197355 etc. In a case where this method is adopted, based on a plurality of shot images including a correction target image which are obtained by consecutive shooting, the movement locus of the subject image during the exposure period of the correction target image is estimated, and, from that movement locus, a degradation function corresponding to a PSF is generated.

As yet another alternative, the degradation function may be generated based on Fourier iteration. A method of generating the degradation function by use of Fourier iteration will be described later in connection with another embodiment.

From the degradation function generated by the degradation function generator 84, the restoration function generator 82a generates a restoration function for eliminating the blur contained in the correction target image. Since methods for generating a restoration function from a degradation function are also well known, no detailed description of any will be given. For example, according to the method disclosed in JP-A-2006-129236, the inverse filter of a PSF as a degradation function is found as a restoration function. The inverse filter of a PSF is represented by the inverse matrix (general inverse matrix) of the matrix represented by the PSF, and the elements composing that inverse matrix (general inverse matrix) correspond to the filter coefficients of the image restoration filter representing the restoration function. From the degradation function, a Wiener filter or a frequency filter may instead be found as the image restoration filter.

The restoration function recording controller 83 records in the header region of the image file FL2 the restoration function data representing the restoration function generated by the restoration function generator 82a. On the other hand, the image data of the correction target image is recorded in the contents region of the image file FL2.

The restoration function generated by the restoration function generator 82a is similar to that described in connection with the fourth embodiment, and in addition the operation of the restoration function recording controller 83 in FIG. 32 is similar to that described in connection with the fourth embodiment. Specifically, the restoration function generated by the restoration function generator 82a is represented by an image restoration filter as shown in FIG. 29, which is a two-dimensional FIR filter, and the restoration function recording controller 83 records, as the restoration function data, the values of Th and Tv representing the filter size of that image restoration filter and the data sequence of the filter coefficients in the header region of the image file FL2 (see FIG. 30A). In a case where the data sequence of the filter coefficients is compressed, the values of Th and Tv, the compressed data sequence, and flag data Fenc representing the compression method are recorded in the header region of the image file FL2 (see FIG. 30B).

Although FIG. 33 shows the procedure in which first the restoration function is generated and then the correction target image and the restoration function data are recorded in the image file FL2, it is also possible to concurrently generate the degradation function and the restoration function and record the correction target image in the image file FL2. For example, it is possible, before or in the middle of the generation of the degradation function or before or in the middle of the generation of the restoration function, to start executing the processing for recording the correction target image in the image file FL2 and, after the recording of the correction target image, to record the restoration function data in the image file FL2. This helps reduce the time for generating the image file FL2 in which the correction target image and the restoration function data are recorded.

The block diagram of the blocks related to playback provided in the image sensing apparatus 1 is the same as that shown in FIG. 26, and their operation is the same as that described in connection with the fourth embodiment (see also FIG. 27).

The fifth embodiment offers benefits similar to those the fourth embodiment offers. Specifically, it is possible to form an apparatus that despite having a simple configuration is capable of image restoration. Moreover, quicker playback of the corrected image is achieved than is conventionally possible.

In the example described above, one degradation function and one restoration function are generated for one correction target image, and the one restoration function is made to act upon the entire correction target image to correct degradation in the correction target image. Alternatively, as in the method described in connection with the fourth embodiment, it is also possible to divide the entire region of one correction target image into n partial regions (where n is an integer of 2 or more) and find a degradation function and a restoration function for each partial region. In that case, the restoration function recording controller 83 in FIG. 32 records in the header region of the image file FL2 the restoration function data for the n restoration functions and the coordinate position of each partial region on the correction target image. Receiving the restoration function data and the coordinate positions of the partial regions from the header region of the image file FL2 via the restoration function reader 91, the restoration processor 92 in FIG. 26 forms an image restoration filter for each partial region. Then the restoration processor 92 executes filtering on the image inside each partial region on the correction target image by use of the corresponding image restoration filter, and thereby generates a filtered image.

### Sixth Embodiment

Next, a sixth embodiment of the invention will be described. The technical features described below in connection with the sixth embodiment are implemented in combination with the fourth or fifth embodiment. The sixth embodiment deals with methods of generating a restoration function which can be adopted in the restoration function generator 82 or 82a in FIG. 24 or 32, and methods of generating a degradation function which can be adopted in the degradation function generator 84 in FIG. 32.

These generation methods are all based on Fourier iteration, and the contents of processing based on Fourier iteration are themselves the same as those described in connection with the first embodiment. In the sixth embodiment, while the first to fourth examples of processing are cited one by one, methods for generating a restoration function and a degradation function which can be applied to the fourth or fifth embodiment will be described. Unless inconsistent, any technical feature described in connection with the first embodiment applies to the fourth and fifth embodiments as well.

### When the First Example of Processing is Adopted

First, a case will be considered where the first example of processing described in connection with the first embodiment is adopted (see FIGS. 2 and 3). In this case, the image sensing apparatus 1 executes shooting and playback operations according to the flow chart of FIG. 2. The processing in steps S1 to S11 is executed at the time of shooting, and the processing in steps S12 and 13 is executed at the time of playback.

In a case where the first example of processing is applied to the fourth embodiment, the restoration function generator 82 in FIG. 24 executes the processing in steps S5 to S11 to find an image restoration filter representing a restoration function. The processing in steps S12 and S13 is executed by the restoration processor 92 in FIG. 26. In a case where the first example of processing is applied to the fifth embodiment, the degradation function generator 84 in FIG. 32 executes the processing in steps S5 to S10 to find a PSF representing a degradation function, and the restoration function generator 82a in FIG. 32 executes the processing in step S11 to find an image restoration filter representing a restoration function.

The processing in each step shown in FIG. 2 is as described in connection with the first embodiment. In step S3, if the exposure time T1 with which the correction target image A1 is obtained is less than the threshold value T_{TH}, the processing of FIG. 2 is ended without generating or recording a restoration function.

### When the Second Example of Processing is Adopted

Second, a case will be considered where the second example of processing described in connection with the first embodiment is adopted (see FIGS. 6 and 7). In this case, the image sensing apparatus 1 executes shooting and playback operations according to the flow chart of FIG. 6. The processing in steps S20 to S29, S10, and S11 is executed at the time of shooting, and the processing in steps S12 and 13 is executed at the time of playback.

In a case where the second example of processing is applied to the fourth embodiment, the restoration function generator 82 in FIG. 24 executes the processing in steps S25 to S29, S10, and S11 to find an image restoration filter representing a restoration function. The processing in steps S12 and S13 is executed by the restoration processor 92 in FIG. 26. In a case where the second example of processing is applied to the fifth embodiment, the degradation function generator 84 in FIG. 32 executes the processing in steps S25 to S29 and S10 to find a PSF representing a degradation function, and the restoration function generator 82a in FIG. 32 executes the processing in step S11 to find an image restoration filter representing a restoration function.

The processing in each step shown in FIG. 6 is as described in connection with the first embodiment. In step S23, if the exposure time T1 with which the correction target image B1 is obtained is less than the threshold value T_{TH}, the processing of FIG. 6 is ended without generating or recording a restoration function.

### When the Third Example of Processing is Adopted

Third, a case will be considered where the third example of processing described in connection with the first embodiment is adopted (see FIGS. 9 and 10). In this case, the image sensing apparatus 1 executes shooting and playback operations according to the flow chart of FIG. 9. The processing in steps S30 to S40, S10, and S11 is executed at the time of shooting, and the processing in steps S12 and 13 is executed at the time of playback.

In a case where the third example of processing is applied to the fourth embodiment, the restoration function generator 82 in FIG. 24 executes the processing in steps S35 to S40, S10, and S11 to find an image restoration filter representing a restoration function. The processing in steps S12 and S13 is executed by the restoration processor 92 in FIG. 26. In a case where the third example of processing is applied to the fifth embodiment, the degradation function generator 84 in FIG. 32 executes the processing in steps S35 to S40 and S10 to find a PSF representing a degradation function, and the restoration function generator 82a in FIG. 32 executes the processing in step S11 to find an image restoration filter representing a restoration function.

The processing in each step shown in FIG. 9 is as described in connection with the first embodiment. In step S33, if the exposure time T1 with which the correction target image C1 is obtained is less than the threshold value T_{TH}, the processing of FIG. 9 is ended without generating or recording a restoration function.

### When the Fourth Example of Processing is Adopted

Fourth, a case will be considered where the fourth example of processing described in connection with the first embodiment is adopted (see FIGS. 12 and 13). In this case, the image sensing apparatus 1 executes shooting and playback operations according to the flow chart of FIG. 12. The processing in steps S50 to S59, S10, and S11 is executed at the time of shooting, and the processing in steps S12 and 13 is executed at the time of playback.

In a case where the fourth example of processing is applied to the fourth embodiment, the restoration function generator 82 in FIG. 24 executes the processing in steps S55 to S59, S10, and S11 to find an image restoration filter representing a restoration function. The processing in steps S12 and S13 is executed by the restoration processor 92 in FIG. 26. In a case where the fourth example of processing is applied to the fifth embodiment, the degradation function generator 84 in FIG. 32 executes the processing in steps S55 to S59 and S10 to find a PSF representing a degradation function, and the restoration function generator 82a in FIG. 32 executes the processing in step S11 to find an image restoration filter representing a restoration function.

The processing in each step shown in FIG. 12 is as described in connection with the first embodiment. In step S53, if the exposure time T1 with which the correction target image D1 is obtained is less than the threshold value T_{TH}, the processing of FIG. 12 is ended without generating or recording a restoration function.

In the first to fourth examples of processing, Fourier iteration is executed by use, as an initially restored image, of an image based on a reference image. This offers benefits as mentioned in connection with the first embodiment. Alternatively, it is also possible to perform Fourier iteration by use, as an initially restored image, of an image based on a correction target image, or a random image, and derive a PSF and an image restoration filter. This derivation method may be applied to the fourth or fifth embodiment. For example, in a case where the first example of processing is adopted (see FIG. 3), it is possible to perform Fourier iteration by use, as a degraded image and an initially restored image, of a small image A1a extracted from the correction target image A1 without acquiring a reference image A2, and derive a PSF and an image restoration filter. In this case, it is not possible to benefit from the use, as an initially restored image, of an image based on a reference image, but it is possible to obtain the benefits unique to the fourth or fifth embodiment.

### Modifications and Variations

The specific values given in the description above are merely examples, which, needless to say, may be modified to any other values. In connection with the embodiments described above, modified examples or supplementary explanations applicable to them will be given below in Notes 1 to 3. Unless inconsistent, any part of the contents of these notes may be combined with any other.

Note 1: The read-out controller 41, the restoration function generator 42, and the restoration processor 43 in FIG. 15 may be provided in an apparatus (e.g. a personal computer) other than the image sensing apparatus 1.

Note 2: The image sensing apparatus 1 of FIG. 1 may be realized with hardware, or with a combination of hardware and software. In particular, the functions of the blocks shown in FIGS. 14, 15, 20, 24, 26, and 32 (except the recording medium 16) may be realized with hardware, with software, or with a combination of hardware and software, and these functions may be realized in an apparatus (such as a computer) external to the image sensing apparatus 1.

In a case where the image sensing apparatus 1 is built with software, a block diagram showing the blocks realized with software serves as a functional block diagram of those blocks. All or part of the functions realized by the blocks shown in FIGS. 14, 15, 20, 24, 26, and 32 (except the recording medium 16) may be prepared in the form of a software program so that, when this software program is executed on a program executing apparatus (e.g. a computer), those functions are realized.

Note 3: For example, the following interpretations are possible. The image acquirer 31, the small image cutter 32, and the recording controller 33 in FIG. 14 or 20 constitute an image recording apparatus. This image recording apparatus may include the image processor 34 in FIG. 20. The read-out controller 41, the restoration function generator 42, and the restoration processor 43 in FIG. 15 constitute an image correcting apparatus.

In the fourth embodiment, the image acquirer 81, the restoration function generator 82, and the restoration function recording controller 83 in FIG. 24 constitute an image recording apparatus. In the fifth embodiment, the degradation function generator 84, the restoration function generator 82a, and the restoration function recording controller 83 in FIG. 32 constitute an image recording apparatus. The restoration function reader 91 and the restoration processor 92 in FIG. 26 constitute an image correcting apparatus.

What is claimed is:

1. An image recording apparatus for acquiring a main image from an image sensing portion and recording the main image on a recording medium, the image recording apparatus comprising:
an image acquirer acquiring, when acquiring the main image from the image sensing portion, also a short-exposure image shot with an exposure time shorter than an exposure time of the main image;
a partial image cutter cutting out a partial image from the short-exposure image; and
a recording controller recording, on the recording medium, in association with the main image, a sub image obtained from the partial image, along with a cut-out position of the partial image.

2. The image recording apparatus according to claim 1, further comprising:
an image processor applying predetermined image processing on the partial image cut out by the partial image cutter,
wherein the recording controller records, on the recording medium, as the sub image, the partial image having undergone the image processing.

3. The image recording apparatus according to claim 1, wherein
the short-exposure image includes first and second reference images,
the partial image cutter cuts out a partial image from each of the reference images, and
the sub image is obtained by performing weighted addition on the partial images of the first and second reference images.

4. The image recording apparatus according to claim 1, wherein
the short-exposure image includes first and second reference images,
the partial image cutter cuts out a partial image from each of the reference images, and
the sub image is obtained from the partial image of the first reference image or the partial image of the second reference image.

5. An image correcting apparatus comprising:
a read-out controller reading out the sub image and the cut-out position from the recording medium according to claim 1; and
a corrector correcting the main image recorded on the recording medium based on contents read out by the read-out controller.

6. The image correcting apparatus according to claim 5,
wherein the corrector cuts out a partial image from the main image based on the cut-out position read out, and corrects the main image based on a partial image of the main image and the sub image.

7. The image correcting apparatus according to claim 6, wherein
the corrector comprises a restoration function generator estimating, based on the partial image of the main image and the sub image, condition of degradation in the main image due to blur and generating a restoration function for correcting the degradation, and
the corrector corrects the degradation of the main image by making the restoration function act upon the main image.

8. An image sensing apparatus comprising the image recording apparatus and the image sensing portion according to claim 1.

9. An image recording method for acquiring a main image from an image sensing portion and recording the main image on a recording medium, the image recording method comprising:
an image acquisition step of acquiring, when acquiring the main image from the image sensing portion, also a short-exposure image shot with an exposure time shorter than an exposure time of the main image;
a partial image cutting step of cutting out a partial image from the short-exposure image; and
a recording control step of recording, on the recording medium, in association with the main image, a sub image obtained from the partial image, along with a cut-out position of the partial image.

10. An image recording apparatus for acquiring an original image from an image sensing portion and recording the original image on a recording medium, the image recording apparatus comprising:
an image acquirer acquiring, when acquiring the original image from the image sensing portion, also a reference image shot with an exposure time shorter than an exposure time of the original image;
a restoration function generator generating, based on the original image and the reference image, a restoration function for correcting degradation in the original image due to blur; and
a recording controller recording, on the recording medium, in association with the original image, restoration function data representing the restoration function.

11. An image recording apparatus for acquiring an original image from an image sensing portion and recording the original image on a recording medium, the image recording apparatus comprising:
a degradation function generator generating a degradation function representing condition of degradation in the original image due to blur;
a restoration function generator generating, from the degradation function, a restoration function for correcting the degradation; and
a recording controller recording, on the recording medium, in association with the original image, restoration function data representing the restoration function.

12. The image recording apparatus according to claim 10,
wherein the restoration function is represented by a two-dimensional FIR filter.

13. The image recording apparatus according to claim 11,
wherein the restoration function is represented by a two-dimensional FIR filter.

14. The image recording apparatus according to claim 12,
wherein the recording controller records, on the recording medium, as the restoration function data, a filter size of and filter coefficients of the two-dimensional FIR filter.

15. The image recording apparatus according to claim 13,
wherein the recording controller records, on the recording medium, as the restoration function data, a filter size of and filter coefficients of the two-dimensional FIR filter.

16. The image recording apparatus according to claim 14,
wherein the recording controller comprises a compressor compressing the filter coefficients, and records, on the recording medium, as the restoration function data, the filter size, the compressed filter coefficients, and data representing a compression method of the filter coefficients.

17. The image recording apparatus according to claim 15,
wherein the recording controller comprises a compressor compressing the filter coefficients, and records, on the recording medium, as the restoration function data, the filter size, the compressed filter coefficients, and data representing a compression method of the filter coefficients.

18. An image correcting apparatus comprising:
a restoration function reader reading out the restoration function data from the recording medium according to claim 10; and
a corrector correcting, by using the restoration function data read out, degradation in the original image recorded on the recording medium.

19. An image correcting apparatus comprising:
a restoration function reader reading out the restoration function data from the recording medium according to claim 11; and
a corrector correcting, by using the restoration function data read out, degradation in the original image recorded on the recording medium.

20. An image sensing apparatus comprising the image recording apparatus and the image sensing portion according to claim 10.

21. An image sensing apparatus comprising the image recording apparatus and the image sensing portion according to claim 11.

22. An image recording method for acquiring an original image from an image sensing portion and recording the original image on a recording medium, the image recording method comprising:
an image acquisition step of acquiring, when acquiring the original image from the image sensing portion, also a reference image shot with an exposure time shorter than an exposure time of the original image;
a restoration function generation step of generating, based on the original image and the reference image, a restoration function for correcting degradation in the original image due to blur; and
a restoration function recording step of recording, on the recording medium, in association with the original image, restoration function data representing the restoration function.

23. An image recording method for acquiring an original image from an image sensing portion and recording the original image on a recording medium, the image recording method comprising:
a degradation function generation step of generating a degradation function representing condition of degradation in the original image due to blur;
a restoration function generation step of generating, from the degradation function, a restoration function for correcting the degradation; and
a restoration function recording step of recording, on the recording medium, in association with the original image, restoration function data representing the restoration function.
